(19) United States
(12) Patent Application Publication
(10) Pub. No.: US 2026/0318595 A1
(43) Pub. Date: Oct. 15, 2026

(54) KILN SYSTEM AND METHOD

(71) Applicants: Thomas E. Luthy, Norwalk, CT (US); Blake Ryan Squires, Akron, OH (US); Wesley Schroeder, Seville, OH (US); Michael Maczuzak, Cleveland, OH (US)

(72) Inventors: Thomas E. Luthy, Norwalk, CT (US); Blake Ryan Squires, Akron, OH (US); Wesley Schroeder, Seville, OH (US); Michael Maczuzak, Cleveland, OH (US)

(21) Appl. No.: 19/678,690

(22) Filed: May 15, 2026

Related U.S. Application Data
(63) Continuation-in-part of application No. 18/545,639, filed on Dec. 19, 2023.
(60) Provisional application No. 63/433,603, filed on Dec. 19, 2022.

(51) Int. Cl. F26B 3/02; F26B 9/06; F26B 25/00

(52) U.S. Cl. CPC F26B 3/02; F26B 9/06; F26B 25/008

(57) ABSTRACT

A kiln includes a cabinet that defines a chamber, an inlet to the chamber, an outlet from the chamber, and a heat module. The heat module includes a housing fixed to an exterior of the cabinet, the housing defines an interior fluidly connected to the chamber through the inlet and the outlet. The heat module also includes a heating element positioned within the interior, and a blower assembly positioned within the interior, where the blower assembly directs airflow from the heating element, through the inlet, and toward the chamber. The heat module has an exterior footprint smaller than a horizontal cross-sectional area along a floorspace in the chamber, and an exterior height smaller than a height of the chamber.

### CROSS-REFERENCE TO RELATED APPLICATIONS

This application claims priority to U.S. Provisional Patent Application Ser. No. 63/433,603 filed Dec. 19, 2022, entitled “FIREWOOD KILN”, and is a continuation-in-part of U.S. patent application Ser. No. 18/545,639 filed Dec. 19, 2023, entitled “FIREWOOD KILN”, the disclosure of which are incorporated by reference in entirety herein.

### BACKGROUND

Dry wood is critical in many circumstances, from woodworking to campfires. For example, wood fires typically utilize dry wood as fuel for the fire to control unpleasant effects such as excessive smoke as well as crackling and popping, which is a by-product of moisture and steam in green, damp or wet wood. Typically, users store wood outside such that the wood is subject to the elements such as rain, snow, humidity, and/or the like. Wet or damp wood produces a good amount of black smoke which, in addition to inconvenience, can be painful to inhale and contains harmful elements. Further, the wet or damp wood does not burn as hot as drier wood. Currently there is not much data regarding the status of the wood and users are generally subject to the weather in regards to the status of firewood.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

According to an aspect, a firewood kiln for effectively removing moisture, e.g., drying, from wood e.g., firewood, is provided. In particular, a housing that can receive wood within the housing, a sensor unit that can provide readings regarding wood, a control unit that can regulate control factors within the housing to achieve a dryness factor in regards to the wood, and a user device that can interface with the control unit to direct the control unit according to a process for drying the wood.

According to another aspect, a firewood kiln that includes a cabinet component having a chamber that is configured to receive firewood within the chamber is disclosed. The kiln may also include a movable base component that is removably affixed to the cabinet component, and a heat engine assembly that is fluidically coupled to the cabinet having access to the chamber and removably coupled to the movable base component. In addition, the kiln includes a controller that is configured to control operations of the heat engine assembly to dry the firewood to a predetermined dryness.

According to another aspect, a kiln includes a cabinet that defines a chamber, an inlet to the chamber, an outlet from the chamber, and a heat module. The heat module includes a housing fixed to an exterior of the cabinet, the housing defines an interior fluidly connected to the chamber through the inlet and the outlet. The heat module also includes a heating element positioned within the interior, and a blower assembly positioned within the interior, where the blower assembly directs airflow from the heating element, through the inlet, and toward the chamber. The heat module has an exterior footprint smaller than a horizontal cross-sectional area along a floorspace in the chamber, and an exterior height smaller than a height of the chamber.

According to another aspect, a kiln includes a cabinet that defines a chamber, an inlet to the chamber, an outlet from the chamber, and a heat module. The heat module includes a housing fixed to an exterior of the cabinet, where the housing defines an interior fluidly connected to the chamber through the inlet and the outlet. The heat module also includes a heating element positioned within the interior, and a blower assembly positioned within the interior, where the blower assembly directs airflow from the heating element, through the inlet, and toward the chamber. Where the cabinet or the housing define a vent to ambient atmosphere, and include a moisture separation membrane disposed across the vent.

According to another aspect, a kiln includes a cabinet that defines a chamber, an inlet to the chamber, and an outlet from the chamber. The kiln also includes a heat module including a housing fixed to an exterior of the cabinet, where the housing defines an interior fluidly connected to the chamber through the inlet and the outlet. The heat module also includes a heating element positioned within the interior, and a blower assembly positioned within the interior, where the blower assembly directs airflow from the heating element, through the inlet, and toward the chamber. The kiln also includes a sensor that measures a weight of the cabinet, including inventory stored in the cabinet. The kiln also includes a controller operatively connected to the heating element, the blower assembly, and the sensor, where the controller determines a moisture content or weight loss rate of the inventory based on measured weights of the cabinet by the sensor over time, and ceases operation of the heating element or the blower assembly when the determined moisture content or weight loss rate falls below a predetermined threshold.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

FIG. 1 illustrates an example embodiment of a firewood kiln according to aspects of the subject disclosure.

FIG. 2 illustrates another example embodiment of a firewood kiln according to aspects of the subject disclosure.

FIG. 3 illustrates an example embodiment of a firewood kiln tarp according to aspects of the subject disclosure.

FIGS. 4A-4B illustrate another example embodiment of a firewood kiln according to aspects of the subject disclosure.

FIGS. 5A-5B illustrate the example embodiment of a firewood kiln of FIGS. 4A-4B according to aspects of the subject disclosure.

FIGS. 6A-6B illustrate another example embodiment of a firewood kiln according to aspects of the subject disclosure.

FIGS. 7A-7B illustrate components of a firewood kiln according to aspects of the subject disclosure.

FIGS. 8A-8B illustrate components of a firewood kiln according to aspects of the subject disclosure.

FIG. 9 illustrates an example controller screen of a firewood kiln according to aspects of the subject disclosure.

FIG. 10 illustrates another example embodiment of a firewood kiln according to aspects of the subject disclosure.

FIG. 11 illustrates another example embodiment of a firewood kiln according to aspects of the subject disclosure.

FIG. 12 illustrates the example embodiment of a firewood kiln shown in FIG. 11 according to aspects of the subject disclosure.

FIG. 13 illustrates the example embodiment of a firewood kiln shown in FIG. 11 according to aspects of the subject disclosure.

FIGS. 14A-14B illustrate the example embodiment of a firewood kiln shown in FIG. 11 according to aspects of the subject disclosure.

FIG. 15 illustrates another example embodiment of a firewood kiln according to aspects of the subject disclosure.

FIG. 16A-16B illustrate the example embodiment of a firewood kiln shown in FIG. 15 according to aspects of the subject disclosure.

FIG. 17 illustrates another example embodiment of a firewood kiln according to aspects of the subject disclosure.

FIG. 18 illustrates the example embodiment of a firewood kiln shown in FIG. 17 according to aspects of the subject disclosure.

FIG. 19 illustrates the example embodiment of a firewood kiln shown in FIG. 17 according to aspects of the subject disclosure.

FIG. 20 illustrates the example embodiment of a firewood kiln shown in FIG. 17 according to aspects of the subject disclosure.

FIGS. 21A-21D illustrate the example embodiment of a firewood kiln shown in FIG. 17 according to aspects of the subject disclosure.

FIGS. 22A-22B illustrate the example embodiment of a firewood kiln shown in FIG. 17 according to aspects of the subject disclosure.

FIG. 23 is a functional block diagram of a controller for use in a kiln system in accordance with one embodiment.

FIG. 24 illustrates a front perspective view of an example embodiment of a firewood kiln according to aspects of the subject disclosure, including a heat module fixed with a cabinet.

FIG. 25 illustrates a front perspective view of the example embodiment of a firewood kiln shown in FIG. 24, including the heat module positioned in the cabinet.

FIG. 26 illustrates a back perspective view of the heat module of FIG. 25.

FIG. 27 illustrates a front perspective view of the cabinet shown in FIG. 24, including an inner box.

FIG. 28 illustrates a front perspective view of the cabinet shown in FIG. 24, including an outer box.

FIG. 29 illustrates a side perspective view of the heat module shown in FIG. 24.

FIG. 30 illustrates a top perspective view of a heating element and a blower assembly included in the heat module shown in FIG. 24.

FIG. 31 illustrates a partial, side perspective, interior view of the heat module shown in FIG. 24, including a vent.

FIG. 32 illustrates a partial, side exterior view of the heat module shown in FIG. 24, including the vent.

FIG. 33 illustrates a partial side interior view of the heat module shown in FIG. 24, including the vent.

FIG. 34 is a partial front view of the kiln of FIG. 24, including a door in a closed position.

FIG. 35 is a partial front view of the kiln of FIG. 24, including the door in an open position.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

Moreover, while the word “kiln” is employed throughout, it is to be appreciated that the subject innovation is related to the use of a chamber, e.g., thermally insulated chamber, or other unit that produces temperature(s) and/or air flow(s) sufficient to mitigate moisture or otherwise dry wood including, but, not limited to firewood. While the examples described in detail relate to firewood and the process of preparing wood for burning, it is to be appreciated that the innovation can also be employed to prepare, or remove moisture from, wood (and/or other materials) for other purposes, e.g., woodworking, building, hobbies, smoking, etc. These alternative aspects are to be included within the spirit and/or scope of the innovation and claims appended hereto.

In accordance with some embodiments contemplated herein, one or more sensors may be used to determine a dryness of wood or material within the drying chamber. For example, and without limitation, a weight sensor may be used with output directed towards the blower assembly and heating elements such that upon reaching a predetermined weight, the blower assembly and heating elements cease operations. In another embodiment, a spring or other mechanical, electrical, or electro-mechanical, component (not shown) may be positioned below one or more of the shelves within the chamber. In such an embodiment, as the weight of the wood or other material decreases, e.g., as water or moisture evaporates from such material, the spring or other component extends. A limit switch or other suitable sensor may be positioned such that switch or sensor is mechanically activated as the shelf rises from the decrease in weight. The output of such a switch or other suitable sensor may then cause the blower assembly and/or heating elements to cease operations, as the reduction in weight of the material is used to indicate having reached a sufficient level of dryness, e.g., for burning, shaping, carving, constructing, etc. Accordingly, it will be appreciated that while embodiments set forth herein utilize a controller component, other contemplated embodiments, such as, for example and without limitation, miniature, camping, tailgating, or other small-size factor implementations, may forgo such a controller and operate via mechanical, electrical, or electro-mechanical direct control of the blower/fans and/or heating elements in accordance with the methods described hereinafter.

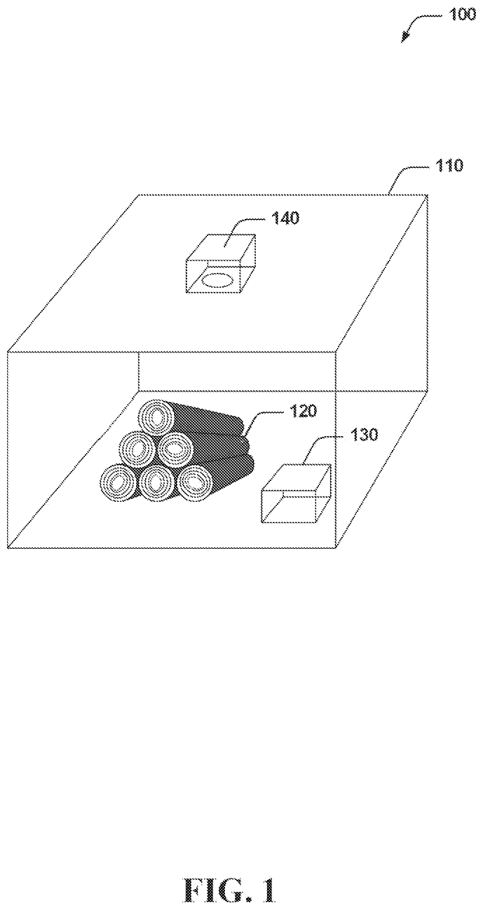

FIG. 1 illustrates an example embodiment of a drying cabinet or kiln according to aspects of the subject disclosure. As used herein, a drying cabinet, kiln 100 or kiln system may be used to prepare firewood 120 for burning in fires. That is, the firewood kiln 100 may be used to facilitate the drying of firewood 120 to reduce its moisture content or percentage sufficiently to enable smoke-free or near smoke-free outcomes when the firewood 120 is burned. As mentioned previously, in some embodiments, the drying cabinet or kiln 100 may be used to dry lumber for construction, wood-working, or other activities where wood having reduced moisture content is desired. In still further embodiments, the drying cabinet or kiln 100 may be used to dry materials other than wood.

As shown in FIG. 1, the kiln 100 includes a housing 110. The housing 110 may be formed in almost any shape or size to accept and store firewood 120, e.g. logs, sticks, split wood, and/or the like. According to some aspects, the housing 110 may be constructed of a rigid or flexible (e.g., adjustable) shape to accommodate a variety of quantities and types of firewood 120. In some embodiments, the kiln 100 and/or the housing 110 may be adequately sized for residential use. In some embodiments, the housing 110 is thermally insulated. In yet other embodiments, the housing 110 is made of plastic, metal, composite, alloy, wood, moisture wicking material, a combination of materials, and/or the like. In some embodiments, the housing 110 may include shelving, multiple zones, compartments, and/or the like. In still other embodiments, the housing 110 may include a door, flap, access panel, and/or the like for loading and unloading the firewood 120 into the housing 110.

The kiln 100 may include a sensor unit 130. The sensor unit 130 may include a sensor, a sensor array, and/or the like. In some embodiments, the sensor unit 130 may correspond to a series of sensors that are selectively dispersed within the housing 110 to provide accurate sensor readings. The sensor unit 130 may collect sensor readouts of the firewood 120, air within the housing 110, ambient factors outside the housing 110, and/or the like. For example, the sensor unit 130 may include a humidity reading, moisture content, or temperature reading of the firewood 120 and/or the air within the housing 110. The sensor unit 130 may detect the wetness, e.g., the moisture content or percentage dryness, of the firewood 120 such that a determination may be made whether the firewood 120 is in a condition for using to fuel a fire. According to some embodiments, such a determination may correspond to a determination that the firewood 120 has a moisture content below a threshold value, such threshold value being indicative of a combustible item that burns with a predetermined amount of smoke. In some embodiments, the sensor unit 130 may include a camera, or vision component that may detect an amount of firewood 120 within the housing 110. Still further, the sensor unit 130, together with external or internally incorporated logic can consider a number of factors, e.g., time, moisture content, temperature(s), etc., to evaluate and notify of a desired state of the wood within the chamber of the kiln 100. These aspects are described in greater detail below.

The kiln 100 includes a control unit 140. The control unit 140 may apply or provide control actions to the firewood 120 or items within the housing 110. The control unit 140 may selectively provide heat to the housing 110 to control the temperature (and humidity/moisture level(s)) within the housing 110. In some embodiments, the control unit 140 may control a heat air panel to heat the air within the housing 110. The heat air panel can be located on a side, the top, or bottom of the housing 110. In other embodiments, the control unit 140 may control a heat lamp to provide heat to the housing 110. The control unit 140 may optionally include a dehumidifier to control moisture within the housing 110. In some embodiments, the dehumidifier includes a water receptacle for moisture that is removed from the wood. In other embodiments, a desiccant material, such as a reusable canister, may be used to absorb/remove moisture. In some embodiments, the control unit 140 may include a filtration unit to filter air within the housing 110. The control unit 140 may include a vent and/or fan to circulate air or exchange air within the housing unit 110. The control unit 140 may accept user input from a user via a user interface (e.g., panel, mobile device), switches, knobs, settings, and/or the like to apply control actions to the firewood 120. For example, the control unit 140 may include a settable thermostat that controls the temperature within the housing 110.

In some embodiments, the control unit 140 may accept a timing input or follow a recipe or process to dry the firewood 120. The control unit 140 may receive sensor readings from the sensor unit 130. The control unit 140 may apply control actions to the firewood 120 and/or housing 110 based on the sensor readings. For example, the sensor unit 130 provides a temperature reading of 100 degrees Fahrenheit within the housing 110. The control unit 140 may have a temperature setting or process of 160 degrees Fahrenheit for 3 hours. Based on the temperature readings and timing, the control unit 140 may provide heat to the housing 110 until the temperature is 160 degrees Fahrenheit and maintain the temperature for the 3 hour timing window.

The kiln 100 may additionally or alternatively be operated to heat treat the firewood 120 for compliance with quarantine or transport regulations. In this regard, various governmental jurisdictions restrict or prohibit the transport of the firewood 120 across state, county, or other administrative boundaries due to concerns regarding the spread of invasive insects, including, for example and without limitation, the emerald ash borer (Agrilus planipennis). In such jurisdictions, the firewood 120 may be transported only upon demonstrating that the wood has been heat treated to a prescribed core temperature for a prescribed duration sufficient to eliminate target pests or other threats. For example, one such standard requires that the core of the firewood 120 reach a temperature of at least 140 degrees Fahrenheit and maintain that core temperature for a continuous period of at least one hour. Notably, other jurisdictions may impose different time-temperature requirements associated with quarantine or travel regulations, and operation of the kiln 100 may be programmed or adjusted in accordance with any such standard.

The kiln 100 may thus serve a dual function of drying and heat treatment. In some embodiments, both functions are accomplished simultaneously, as a typical drying cycle may meet or exceed the applicable heat-treatment time-temperature requirements. In other embodiments, the control unit 140 executes a dedicated heat-treatment cycle that satisfies the time-temperature requirement without necessarily achieving a target moisture content for combustion. The kiln 100 may achieve higher throughput when operating in a heat-treatment mode because such a dedicated cycle may be shorter than a full drying cycle.

In some embodiments, the control unit 140 includes predetermined programming configured to determine, based on one or more known variables, whether the core of the firewood 120 has reached the prescribed temperature for the prescribed duration. Such known variables may include, a type or species of the firewood 120, an initial moisture content of the firewood 120, an ambient temperature surrounding the kiln 100, a temperature within the housing 110 as measured by the sensor unit 130 a size of the firewood 120 such as a diameter, a length, or a cross-sectional dimension. Using such variables, the control unit 140 may execute a thermal model or lookup table stored in memory to calculate or estimate the time required for the core of the firewood 120 to reach the prescribed temperature at a given chamber temperature, without requiring direct physical measurement of the core temperature of the firewood 120, such as by drilling into the firewood 120 and inserting a thermocouple or other temperature probe. In this manner, the control unit 140 may confirm that firewood 120 up to a certain size has been heat treated to the applicable standard based on the chamber temperature, the elapsed time, and the known thermal properties of the firewood 120, and may generate a notification, display, or record indicating that the heat-treatment cycle has been completed and that the firewood 120 is sterilized or qualified for transport.

In other embodiments, a thermocouple or other suitable temperature probe may be inserted directly into the firewood 120, for example through a drilled hole, to measure the actual core temperature of the firewood 120 during the heat-treatment or drying cycle. In such embodiments, the sensor unit 130 receives the core temperature reading and provides the core temperature reading to the control unit 140, which compares the measured core temperature to the prescribed threshold and determines whether the firewood 120 has been maintained at or above the prescribed core temperature for the prescribed duration. Upon satisfaction of the time-temperature requirement, the control unit 140 may cease heat-treatment operations, issue a notification to the user, or generate a record confirming compliance with the applicable heat-treatment standard.

Further, in aspects, the control unit 140 can manage aroma diffusing processes as desired. For example, a desired aroma or flavor can be added or otherwise diffused into the wood along with the process of drying. In one aspect, the kiln 100 can be equipped with an aroma diffusing unit that can be incorporated within control unit 140 or separately (not shown) whereby the wood within the chamber is exposed to the aroma for a desired amount of time. It will be understood and appreciated that this diffusion of aroma can enhance a user's experience, for example, when using, storing or burning diffused wood. In embodiments, oils, e.g., essential oils, can be employed to effect infusing the wood with a desired scent, aroma or flavor. In aspects, in addition to enhancing scent and aroma, flavored wood can also be used in smoking meats, for example.

In some embodiments, the sensor unit 130 may detect other factors. For example, the sensor unit 130 may detect or determine a type of wood that the firewood 120 is made of, e.g. determining the firewood 120 is cherry wood or maple wood. In these embodiments, the sensor unit 130 may provide the type of wood to the control unit 140. The control unit 140 may adapt the process or recipe for drying the firewood 120 based on the type of wood that is determined by the sensor unit 130. In some embodiments, the control unit 140 and the sensor unit 130 are integrated into a singular unit. It is to be understood and appreciated that, in other aspects, the type of wood can be provided to the control unit 140, thereby incorporating wood characteristics and thereby enabling optimization of processes, e.g., drying, aroma diffusion, etc.

In other embodiments, the control unit 140 may include different efficacy settings. For example, the control unit 140 may provide an “express cycle” option which can dry the firewood 120 quicker than a normal cycle up to a lesser percentage of efficacy. In other aspects, an energy-saver option can be available that dries wood slower thereby conserving energy. Efficacy options can include timers and other controls such that a user can customize control of the unit 100 as desired. In some embodiments, the control unit 140 may accept a user input for efficacy and determine a cycle to achieve the efficacy. For example, the user may want to start a fire in 1 hour as opposed to a normal 3 hour cycle. The user may provide input for 80% efficacy and the control unit 140 may provide extra heat, higher temperatures and/or enhanced air flow to achieve the set efficacy for the shortened timeframe. Notably, drying cycle durations may vary widely depending on factors such as the type and species of wood, the initial moisture content, the size of the firewood 120, ambient conditions, and target output conditions, with typical cycles ranging from approximately 3 hours to 24 hours or more.

In some embodiments, the housing 110, the sensor unit 130, and/or the control unit 140 are powered by a plug in power source, an external battery or batteries, a generator, alternating current power source, direct current power source, solar panels, a combination of sources, and/or the like. In other embodiments, the control unit 140 may adapt the recipe or process according to ambient readings from the sensor unit 130. For example, the sensor unit 130 can determine weather from a forecast or a reading of the environment surrounding the outside of the housing 110, e.g. humidity level of outside air, or rain or prediction of rain. The control unit 140 may adapt the process (e.g., start/stop time, duration, temperature, air flow, etc.) to dry the firewood 120 based on the ambient readings such as providing extra or less heat, providing extra or less outside air, and/or the like.

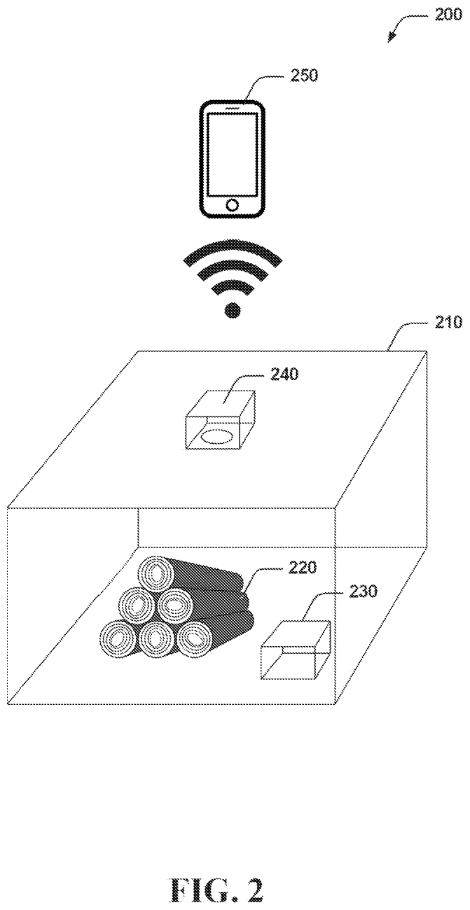

FIG. 2 illustrates another example embodiment of a kiln according to aspects of the subject disclosure. A drying cabinet, firewood kiln 200 or kiln system may be used to prepare firewood 220 for burning in fires. The firewood kiln 200 includes a housing 210. The housing 210 may form almost any shape to accept and store firewood 220, e.g. logs, sticks, split wood, and/or the like. In some embodiments, the housing 210 is insulated. In other embodiments, the housing 210 is made of plastic, metal, composite, alloy, wood, moisture wicking material, a combination of materials, and/or the like. In some embodiments, the housing 210 may include shelving, multiple zones, compartments, and/or the like. In other embodiments, the housing 210 may include a door, flap, access panel, and/or the like for loading and unloading the firewood 220 into the housing 210.

The firewood kiln 200 may include a sensor unit 230. The sensor unit 230 can include a sensor, a sensor array, and/or the like. In some embodiments, the sensor unit 230 may refer to a series of sensors that are selectively dispersed within the housing 210 to provide accurate sensor readings. The sensor unit 230 may collect sensor readouts of the firewood 220, air within the housing 210, ambient factors outside the housing 210, and/or the like. For example, the sensor unit 230 may include a humidity reading or temperature reading of the firewood 220 and/or the air within the housing 210. The sensor unit 230 may detect the wetness of the firewood 220 such that a user can determine whether the firewood 220 is in a condition for using to fuel a fire. In some embodiments, the sensor unit 230 may include a camera, or vision component that is capable of detecting the amount of firewood 220 within the housing 210.

The firewood kiln 200 illustrated in FIG. 2 further includes a control unit 240. The control unit 240 may apply or provide control actions to the firewood 220 or items within the housing 210. The control unit 240 may provide heat to the housing 210 to control the temperature within the housing 210. The control unit 240 may include a dehumidifier to control moisture within the housing 210. The control unit 240 may include a vent and/or fan/blower to circulate air or exchange air within the housing unit 210.

In some embodiments, the control unit 240 may interface with a user device 250, e.g., wired or wireless. The user device 250 may be a smartphone using an application, a personal computer, tablet, fob, and/or the like. The user device 250 may accept user input from a user via a user interface to direct the control unit 240 to apply control actions that ultimately affect the firewood 220. For example, the user device 250 may direct the control unit 240 to a thermostat or temperature setting to control the temperature within the housing 210.

In some embodiments, the user device 250 may provide a timing input or follow a process to dry or treat the firewood 220. The user device 250 and/or the control unit 240 may receive sensor readings from the sensor unit 230. The user device 250 may direct the control unit 240 to apply control actions to the firewood 220 and/or housing 210 based on the sensor readings. For example, the user device 250 determines a process to dry the firewood 220 as 160 degrees Fahrenheit within the housing 210 for 3 hours. The user device 250 may direct the control unit 240 to maintain a temperature of 160 degrees Fahrenheit for 3 hours. As will be appreciated, employing a user device 250 control can enhance operability and convenience such that a user can control and monitor status of the unit, its control unit 240, sensor unit 230 readings, and ultimately wood 220 status remotely.

In other embodiments, the user device 250 may include different efficacy settings. For example, the user device 250 may provide an “express cycle” option which can dry the firewood 220 quicker than a normal cycle up to a lesser percentage of efficacy. In some embodiments, the user device 250 may accept a user input for efficacy and determine a cycle to achieve the efficacy. For example, the user may want to start a fire in a 2 hour cycle as opposed to a normal 3 hour cycle. The user may provide input for 80% efficacy and the control unit 240 may be directed to provide extra heat or higher temperatures to achieve the set efficacy for the shortened timeframe.

In some embodiments, the user device 250 may adapt the recipe or process according to ambient readings from the sensor unit 230. For example, the user device 250 may determine the weather from a forecast of the environment surrounding the outside of the housing 210, e.g., temperature or humidity level of outside air, or rain or prediction of rain. The user device 250 may adapt the process to dry the firewood 220 based on the ambient readings, such as, providing extra or less heat, providing extra or less air flow, providing extra or less outside air, and/or the like. In some embodiments, the user device 250 may determine location or global positioning satellite data to determine weather conditions, ambient conditions, location based conditions, and/or the like that may affect the process to dry the firewood 220. Similarly, in other aspects, some or all of this functionality can be built into the control unit 240.

In some embodiments, the user device 250 may interface with a user to provide recommendations regarding drying the firewood 220. For example, the user device 250 may optionally, and with permission, interface with a calendar of the user to determine if the user is planning on using firewood in the future. The user device 250 may proactively remind the user to start drying the firewood 220. In other embodiments, the user device 250 may direct the control unit 240 to begin drying the firewood 220 at the appropriate (or desired) time such that the firewood 220 is ready to be burned at the time displayed in a calendar entry of the user device 250. In some embodiments, the user device 250 may provide recommendations to the user and/or direct the control unit 240 for preparing the firewood 220. For example, the user device 250 may provide a recommendation to place firewood 220 into the housing 210 based on a weather forecast. Similarly, recommendations may also be based upon, or otherwise consider, machine learning (ML) and artificial intelligence (AI). It will be understood and appreciated that ML/AI aspects can learn and/or be trained utilizing individual user or group user data (and/or other publicly available data) related to historical uses and data.

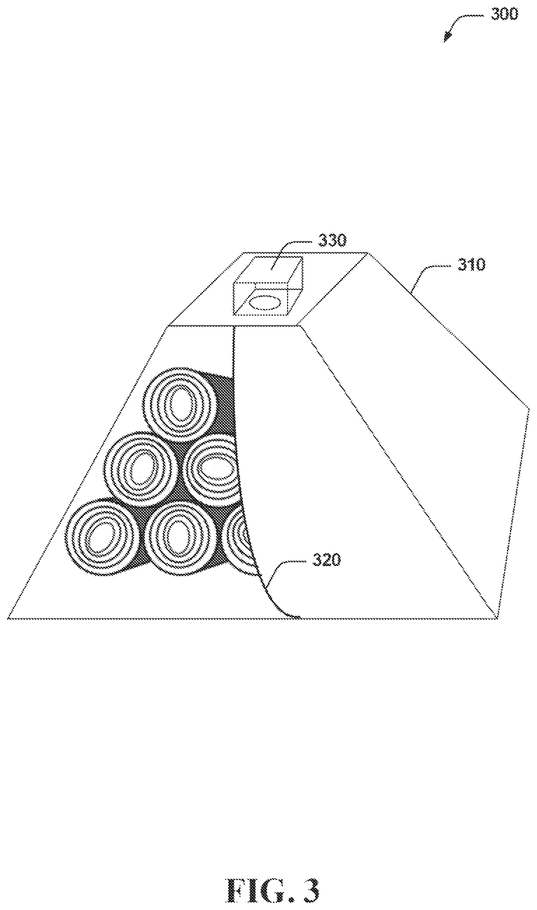

FIG. 3 illustrates an example embodiment of a drying cabinet, firewood kiln or kiln system 300 according to aspects of the subject disclosure. The firewood kiln 300 may include a covering 310. The covering 310 may be a soft or malleable material. The covering 310 may be draped over or covering firewood or a firewood shelving unit or firewood holder. The covering 310 may be an air-tight material, a breathable, and/or an insulated material that allows moisture out without letting moisture to enter, a moisture wicking material, and/or the like. The covering 310 includes an opening 320. The opening 320 may be an air-tight closure mechanism, zipper, or other closure mechanism (e.g., snaps, magnets, Velcro®, etc.) to facilitate covering the firewood. The firewood kiln 300 includes a control unit 330 that can be used in manners with regard to the control units described in detail above.

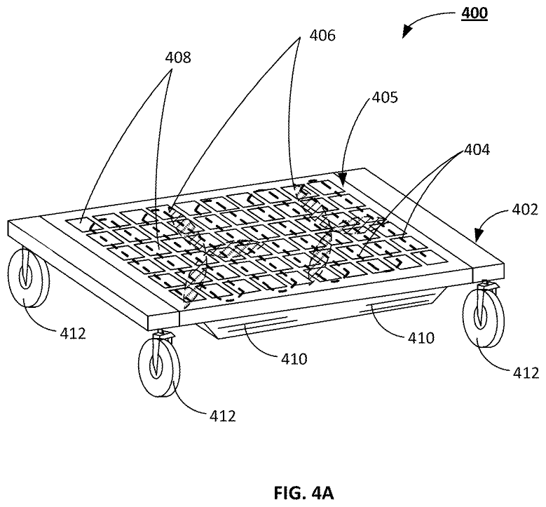

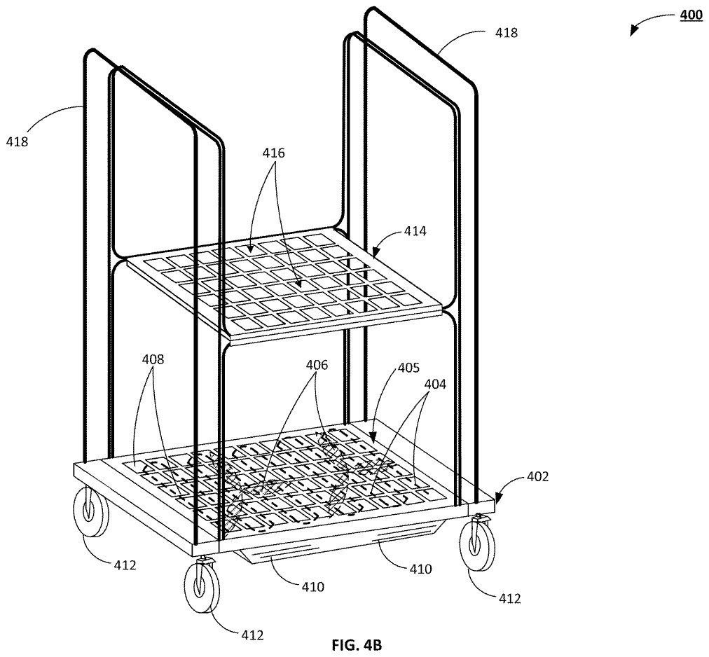

Turning now to FIGS. 4A-4B, there are shown modular components of a drying cabinet, kiln or kiln system 400 in accordance with some embodiments. Such a kiln 400 may be used, for example and without limitation, in the drying or curing of wood or other such materials for a variety of uses, e.g., woodworking, firewood, construction, grilling/smoking, etc. As shown in FIG. 4A, the kiln system 400 includes a modular base component 402, configured with one or more heating elements 404, one or more fans 406, and one or more vents 408 disposed on a top surface 405 of the modular base component 402 to enable heated air to pass upwards through the vents 408. In accordance with some embodiments, the top surface 405 may be constructed of a suitable supportive material configured to support the weight of wood (or other material) to be dried by the kiln 400. Such supportive materials may include, for example and without limitation, metals, metal-alloys, rigid plastics, composites, reinforced fiberglass, or the like. In some embodiments, such material may be configured to retain structural integrity and shape when the kiln 400 is heated, as discussed in greater detail below.

It will be appreciated that while shown in FIG. 4A as two fans 406, the modular base component 402 may be implemented with any number of fans, e.g., 1, 3, 4, 10, 20, etc., and the illustration of FIG. 4A is intended solely as a non-limiting example thereof. The heating elements 404 may be any type of heating element known in the art including, for example and without limitation, radiant heating elements, resistive heating elements, externally fed fluidic heating elements, or the like. In accordance with varying embodiments, the heating elements 404 may be positioned above or below the fans 406, as will be appreciated by the skilled artisan. Although not illustrated in FIG. 4A, the modular base component 402 may further include power and/or control elements configured to control the heating elements 404 and fans 406 responsive to a selected operation schedule or program, as well as to supply electrical power to such heating elements 404 and fans 406.

In some embodiments, the modular base component 402 may include one or more particulate filters (not shown) positioned adjacent inlets 410 to provide filtering of air entering the modular base component 402 prior to heating by the heating elements 404. According to some example embodiments, the modular base component 402 is configured to be movable by one or more operators. In such embodiments, the modular base component 402 may include one or more devices 412 configured to facilitate such movement. Suitable such devices may include, for example and without limitation, rails, gears, casters, wheels, etc. The example embodiment of FIG. 4A illustrates one or more casters 412 positioned on an underside of the modular base component 402 and configured to allow movement of the modular base component 402 in both the x and y directions.

It will be appreciated that the modular base component 402 depicted in FIG. 4A may be implemented in a variety of dimensions, and the shape and orientation illustrated in FIG. 4A is intended solely as one representative example. Turning now to FIG. 4B, there is shown the modular base component 402 of the kiln system 400 including at least one additional shelf 414 positioned a predetermined distance above the top surface 405 of the modular base component 402. In varying embodiments, the shelf 414 may be adjustable, e.g., capable of allowing for a greater or lesser distance relative to the top surface 405. As shown in FIG. 4B, the additional shelf 414 may include one or more vents or holes 416 formed through the material of the shelf 414. In some embodiments, such ventilation allows for circulation of heated air through the shelf 414 to any materials placed on the shelf 414. That is, the fans 406 may operate to pull air in from the filters 410 across the heating elements 404 and force or blow such heated air upwards through the holes/vents 408 and 416, allowing such heated air to flow over and around any materials placed on the top surface 405 and/or shelf 414 to be dried in the kiln 400.

In the embodiment depicted in FIG. 4B, the kiln system 400 includes frames 418, positioned around the perimeter of the modular base component 402 and extending perpendicularly upward therefrom. As illustrated in FIG. 4B, the frames 418 are positioned on opposite ends of the modular base component 402, however other embodiments not shown may include additional frame components positioned at each side of the modular base component 402, or cross-members (not shown) may be used to connect the opposing frame components 418 to each other, as will be appreciated by the skilled artisan in review of this disclosure.

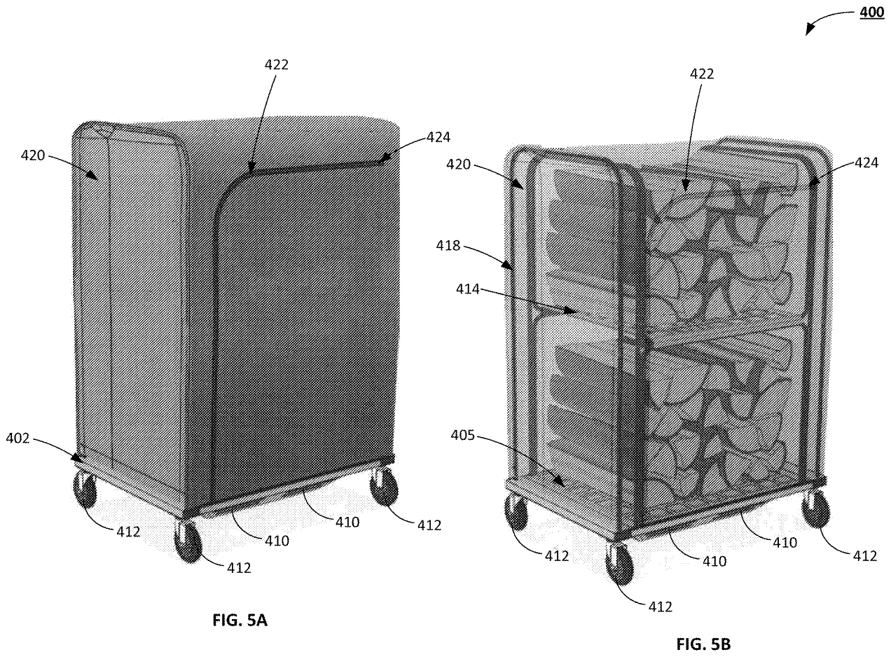

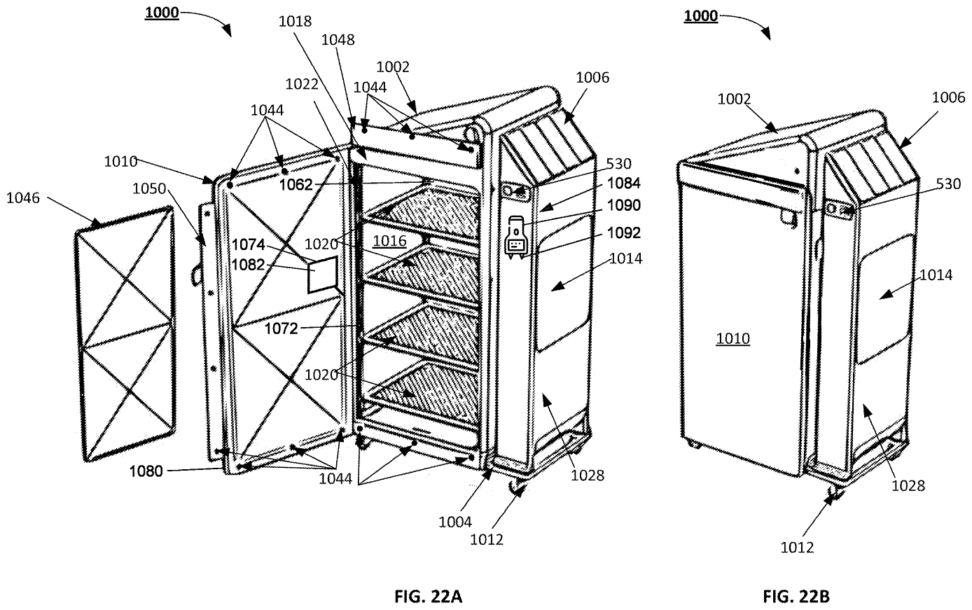

Turning now to FIGS. 5A and 5B, there are shown, respectively, a view of the kiln system 400 encased in a cover 420 and a transparent view of the kiln system 400 with the cover 420 attached and loaded with logs 422 to be dried in accordance with varying embodiments and methods described below. As shown in FIG. 5A, the cover 420 is removably attached to the modular base component 402 and extends over the frames 418, forming a flexible, semi-rigid chamber within which the shelf 414 and upper surface 405 are contained. The cover 420 may be implemented as a single or multi-layered component of fabric or plastic materials. In one example embodiment, the cover 420 may be a three-layered insulated housing that includes an outer layer of material, an insulated layer, and an inner layer of heat-resistant material. One illustrative example of such a cover is shown and discussed in greater detail below, with respect to FIGS. 22A-22B. It is to be understood that the cover may be provided in most any suitable fabric (e.g., flexible, rigid or semi-rigid) and be removable as well as fixed in certain embodiments.

In the embodiment illustrated in FIGS. 5A-5B, the cover 420 includes a sealable flap 422 that may be opened or closed to provide access to the interior of the kiln system 400. The flap 422 may be sealable via a fastener 424, which may include, for example and without limitation, zippers, buttons, snaps, magnetic connectors, or the like. In some embodiments, the fastener 424 may be implemented with accompanying seals or gaskets (not shown) to allow for an airtight or near airtight sealing of the flap 422 to the cover 420 to prevent intrusion of moisture into the chamber of the kiln system 400 during drying operations. FIG. 5B provides a semi-transparent view of the interior of the kiln system 400 loaded with logs for drying (or treating) in accordance with some embodiments.

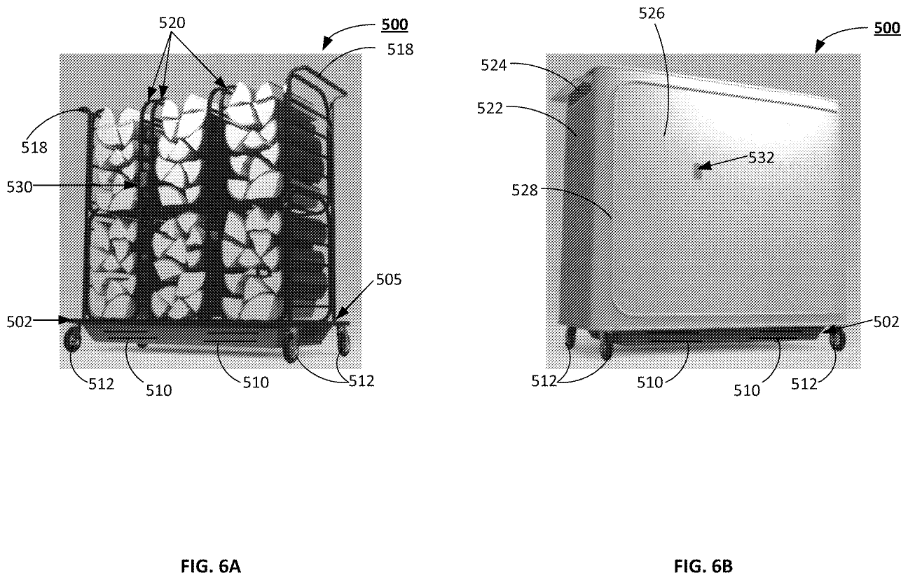

Referring now to FIGS. 6A and 6B, there are shown illustrations of a kiln system 500 in accordance with another embodiment. It will be appreciated that the illustrations of FIGS. 4A-5B depict a generally smaller kiln system 400, suitable, e.g., for use in residential settings. That is, the kiln system 400 may be generally implemented to allow homeowners, campers, travelers, cabin-goers, etc., to prepare dried firewood in accordance with the size shown in FIGS. 4A-5B. FIGS. 6A-6B, however, illustrate a larger version of a kiln system 500 capable of drying a larger quantity of wood or other products. For example, the kiln system 500 may be used in a restaurant, lodge, store, gas station, wood working place (e.g., carpentry, artisans, etc.) and the like, for the production of a larger quantity of ready-to-burn firewood, larger size pieces of wood, or the like. Similarly, while the aspects shown are employed to dry or treat logs having a relatively short length, other aspects can be employed to employ wood and other materials of variable length, larger (e.g., lumber boards/sheets, etc.) or smaller (e.g., hobbyist materials).

As will be appreciated, the kiln system 500 depicted in FIG. 6A, includes a modular base component 502, substantially rectangular in shape, similar to the modular base component 402 of FIGS. 4A-5B. However, the modular base component 502 includes a longer length than that of the modular base component 402 to accommodate a larger amount of products, e.g., wood, for drying. Although not shown in FIG. 6A, the kiln system 500 may be configured with one or more heating elements, one or more fans, and one or more vents disposed on a top surface 505 of the modular base component 502 to enable heated air to pass upwards through the vents or holes in the top surface 505. In accordance with some embodiments, the top surface 505 may be constructed of a suitable supportive material configured to support the weight of wood (or other material) to be dried by the kiln 500. Such supportive materials may include, for example and without limitation, metals, metal-alloys, rigid plastics, reinforced fiberglass, or the like. In some embodiments, such material may be configured to retain structural integrity and shape when the kiln 500 is heated, as discussed in greater detail below. As discussed above with respect to FIG. 4A, the kiln system 500 may be implemented with any number of fans, e.g., 1, 3, 4, 10, 20, etc., and the heating elements used therein may be any type of heating element known in the art including, for example and without limitation, radiant heating elements, resistive heating elements, externally fed fluidic heating elements, or the like. Although not illustrated in FIGS. 6A and 6B, the modular base component 502 may further include power and/or control elements configured to control the heating elements and fans responsive to a selected operation schedule or program, as well as to supply electrical power to such heating elements and fans.

In some embodiments, the modular base component 502 may include one or more particulate filters (not shown) positioned adjacent inlets 510 to provide filtering of air entering the modular base component 502 prior to heating by the heating elements. According to some exemplary embodiments, the modular base component 502 is configured to be movable by one or more operators. In such embodiments, the modular base component 502 may include one or more devices 512 configured to facilitate such movement. Suitable such devices may include, for example and without limitation, rails, gears, casters, wheels, etc. The example embodiment of FIG. 6A illustrates one or more casters 512 positioned on an underside of the modular base component 502 and configured to allow movement of the modular base component 502 in both the x and y directions.

In the embodiment depicted in FIG. 6A, the kiln system 500 includes frames 518, positioned around the perimeter of the modular base component 502 and extending perpendicularly upward therefrom. As illustrated in FIG. 6A, the frames 518 are positioned on opposite ends of the modular base component 502, however other embodiments not shown may include additional frame components positioned at each side of the modular base component 502, or cross-members (not shown) may be used to connect the opposing frame components 518 to each other, as will be appreciated by the skilled artisan.

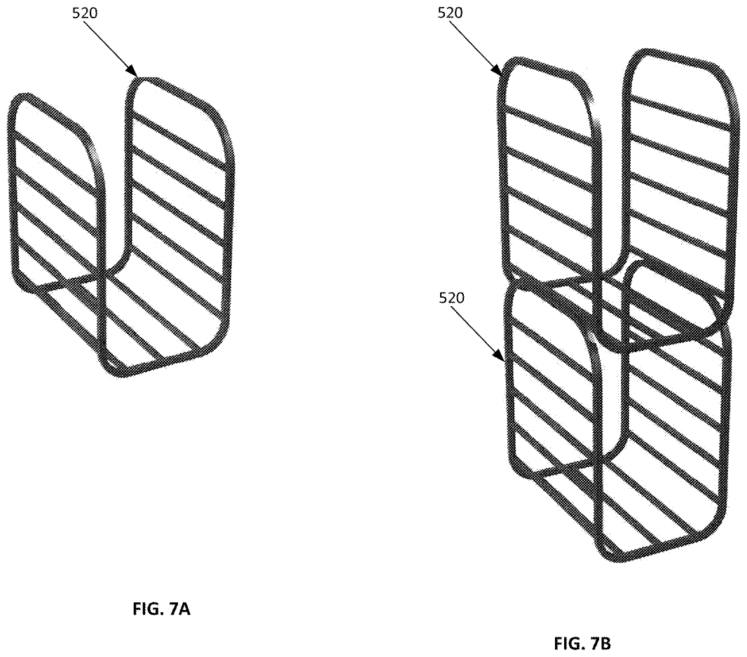

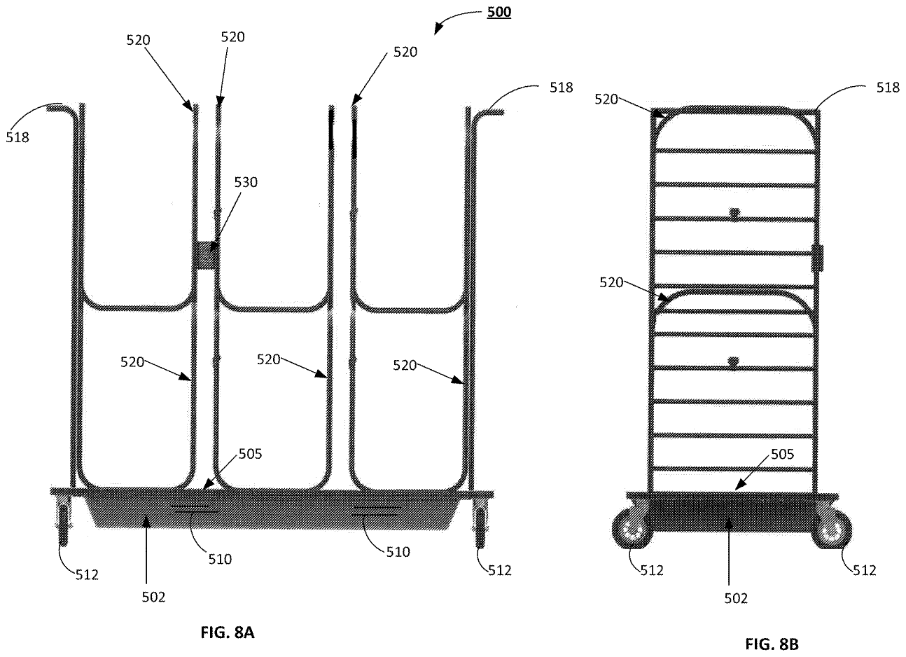

The kiln system 500, as shown, includes one or more cages 520, capable of being joined or stacked as needed, with each cage 520 configured to hold a predetermined volume of material to be dried. As illustrated in FIG. 6A, six (6) cages 520 are capable of being placed or stacked on the modular base component 502 to hold wood or other materials in place for drying operations. The kiln system 500 of FIG. 6A depicts a first row of cages 520 positioned directly on the top surface 505 of the modular base unit 502 between the opposing frame components 518. A second row of cages 520 is positioned on the first row, resting on or secured to the first row of cages 520 in accordance with varying embodiments. A more detailed illustration of an example embodiment of the cages 520 is provided in FIG. 7A (single cage 520) and FIG. 7B (stacked pair of cages 520). It will be appreciated that the number of cages 520 and rows may be adjusted in accordance with size of the kiln system 500, size of the cages 520, amount of wood or material to be dried, and the like. FIGS. 8A and 8B show respective front and side views of the modular base component 502 and cages 520 of FIGS. 6A-6B. Thus, the illustrations in FIGS. 6A-8B are intended as a non-limiting example of such a configuration of the kiln system 500. Additionally, although not illustrated, each cage can be installed upon rails, slide, castors, wheels, etc. so as to enable the cage to be easily removed as desired.

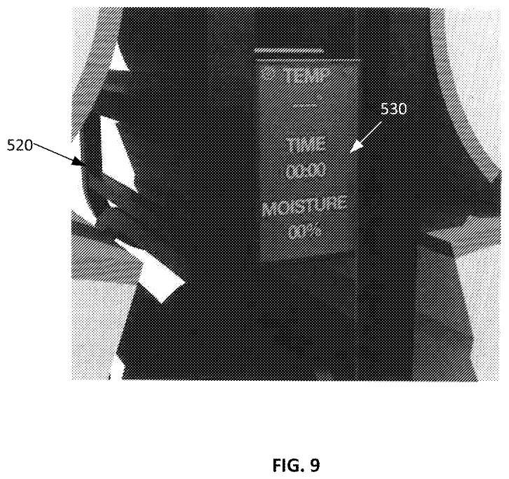

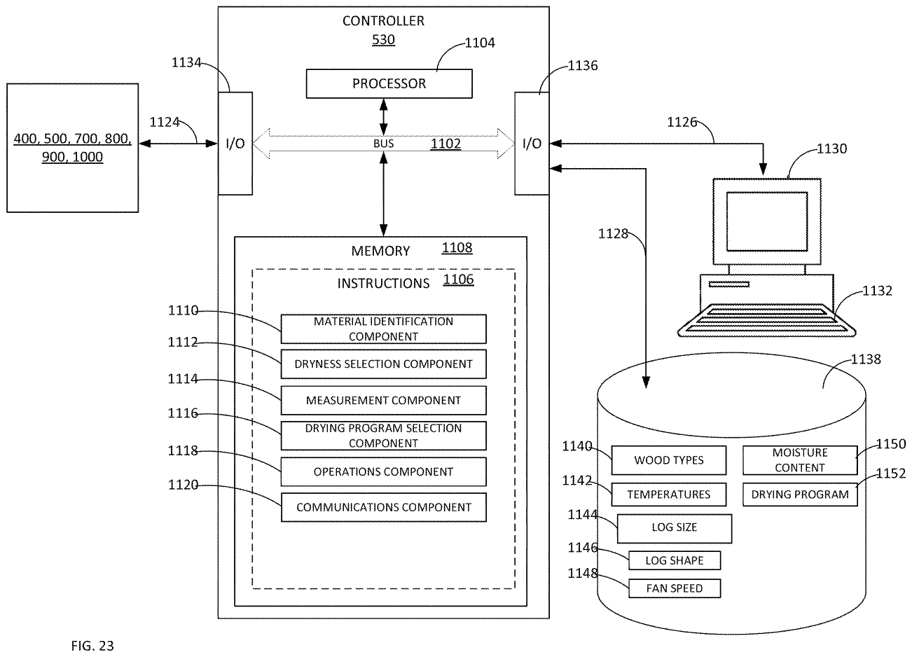

Returning to FIG. 6A, the kiln system 500 illustrated therein further includes a controller 530 configured to control operations of the kiln system 500 in accordance with some embodiments. As shown in FIG. 8A, a controller 530 is positioned adjacent two cages 520, however it will be appreciated that the positioning of the controller 530 and corresponding window 532 may be altered in accordance with varying embodiments. In such embodiments, the controller 530 may be in data communication (wired or wireless) with one or more sensors (not shown) configured to measure one or more properties associated with the material to be dried as well as operations of the kiln system 500, (e.g., temperature, wood/material moisture content, airflow, weight, time, internal and/or exit air moisture content, etc.). Further, the controller 530 may be configured to control or direct operations of the heating and fan components of the modular base component 502, as well as to communicate with one or more external devices, as discussed in greater detail below. FIG. 9 provides an illustration of an example display of information of the controller 530 positioned adjacent to the two cages 520 referenced above with respect to FIG. 8A. Additional discussion of the controller 530 is set forth below with respect to FIG. 23. As described herein, in aspects, this display information, as well as input control data, can be input, retrieved and/or manipulated via a remote device such as a smartphone or other suitable device.

Turning now to FIG. 6B, there is shown a view of the kiln system 500 encased in a cover 522 that includes an exhaust port 524 and a sealable flap 526 located on one side of the cover 522. The sealable flap 526 portion of the cover 522 includes a fastener 528 capable of sealing the flap 526 relative to the cover 522. The fastener 528 may include, for example and without limitation, zippers, buttons, snaps, magnetic connectors, or the like. In some embodiments, the fastener 528 may be implemented with accompanying seals or gaskets (not shown) to allow for an airtight or near airtight sealing of the flap 526 to the cover 522 to prevent intrusion of moisture into the chamber of the kiln system 500 during drying operations. The sealable flap 526 may further include a transparent window 532 positioned to allow for view of the controller 530 in varying embodiments. As shown in FIG. 6B, the cover 522 is removably attached to the modular base component 502 and extends over the frames 518, forming a flexible, semi-rigid chamber within which the cages 520 and upper surface 505 are contained. The cover 522 may be implemented as a single or multi-layered component of fabric or plastic materials. In one example embodiment, the cover 522 may be a three-layered insulated housing that includes an outer layer of material, an insulated layer, and an inner layer of heat-resistant material.

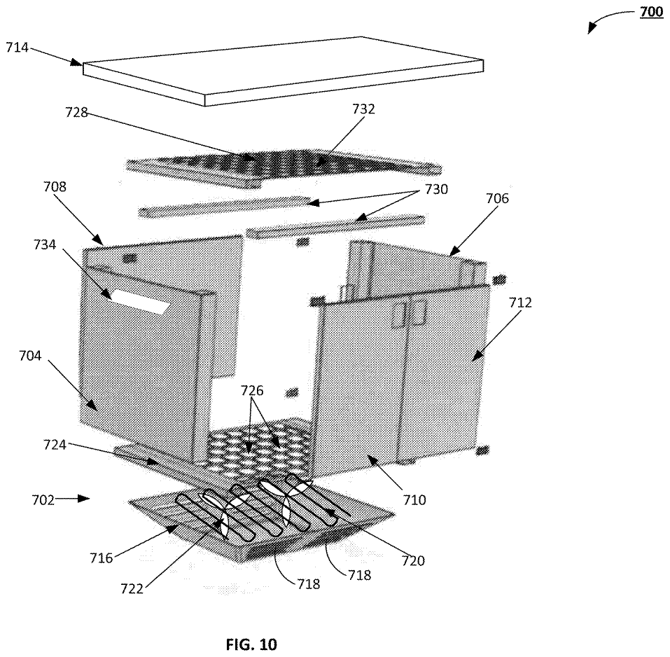

Turning now to FIG. 10, there is shown a kiln system 700 utilizing fixed, e.g., rigid, walls in place of the cover in accordance with another embodiment. As shown in FIG. 10, the kiln system 700 includes a base component 702, a first side panel 704, an opposing second side panel 706, a rear panel 708, a first door panel 710, a second door panel 712, and a top panel 714. As shown in FIG. 10, the base component 702 includes one or more heating elements 720, one or more fans 722, positioned in a housing 716 and one or more vents 726 disposed on a top surface 724 of the base component 702 coupled to the housing 716 to enable heated air to pass upwards through the vents 726. In accordance with some embodiments, the top surface 724 may be constructed of a suitable supportive material configured to support the weight of wood (or other material) to be dried by the kiln 700. Such supportive materials may include, for example and without limitation, metals, metal-alloys, rigid plastics, reinforced fiberglass, or the like. In some embodiments, such material may be configured to retain structural integrity and shape when the kiln 700 is heated, as discussed in greater detail below.

It will be appreciated that while shown in FIG. 10 as two fans 722, the base component 702 may be implemented with any number of fans, e.g., 1, 3, 4, 10, 20, etc., and the illustration of FIG. 10 is intended solely as a non-limiting example thereof. The heating elements 720 may be any type of heating element known in the art including, for example and without limitation, radiant heating elements, resistive heating elements, externally fed fluidic heating elements, or the like. In accordance with varying embodiments, the heating elements 720 may be positioned above or below the fans 722, as will be appreciated by the skilled artisan upon review of this disclosure. Although not illustrated in FIG. 10, the base component 702 may further include power and/or control elements configured to control the heating elements 720 and fans 722 responsive to a selected operation schedule or program, as well as to supply electrical power to such heating elements 720 and fans 722. In some embodiments, the base component 702 may include one or more particulate filters (not shown) positioned adjacent inlets 718 to provide filtering of air entering the housing 716 of the base component 702 prior to heating by the heating elements 720.

The kiln system 700 may include at least one additional shelf 728 positioned a predetermined distance above the top surface 724 of the base component 702. Supports or rails 730 are positioned perpendicularly between the opposing first and second side panels 704 and 706, upon which the shelf 728 is removably affixed. In varying embodiments, the shelf 728 and rails/supports 730 may be adjustable, e.g., capable of allowing for a greater or lesser distance relative to the top surface 724. As shown in FIG. 10, the shelf 728 includes one or more vents or holes 732 formed through the material of the shelf 728. In some embodiments, such ventilation allows for circulation of heated air through the shelf 728 to any materials placed on the shelf 728. That is, the fans 722 may operate to pull air in from the filters/inlets 718 across the heating elements 720 and force or blow such heated air upwards through the holes/vents 726 and 732, allowing such heated air to flow over and around any materials placed on the top surface 724 and/or shelf 728 to be dried in the kiln 700.

As shown in FIG. 10, the kiln system 700 may include one or more exhaust vents 734 positioned on any one or more of the opposing first and second side panels 704-706, the rear panel 708, the top panel or cover panel 714, or the like. In some embodiments, the panels 704-708, the doors 710-712, and top panel 714 may be constructed of single or multiple layers of rigid or semi-rigid materials. In some embodiments, such multi-layered panels 704-714 may include a heat resistant component/layer facing the interior of the kiln 700, one or more insulated layers adjacent to the heat resistant component/layer, and an exterior layer. For example, the heat-resistant layer may be constructed of a suitable rigid metal or metal-alloy material having heat resistant properties, the insulated-layer may be constructed of fiberglass, aerogel, or other semi-rigid material, and the exterior layer may be constructed of any suitable metal, metal alloy or other suitable rigid material. Other formulations of the panels 704-714 may be implemented in accordance with various embodiments contemplated herein. The various panels 704-714 may be coupled together via any suitable methods, including, for example and without limitation, bolted together, riveted together, welded together, removably-fastened together, slot/tab connections, or combinations thereof. In some embodiments, multiple side, rear, and door panels 704-714 may be stacked on top of each other to increase the interior volume of the kiln system 700. In some embodiments, the first door 710 and the second door 712 may be implemented with accompanying seals or gaskets (not shown) to allow for an airtight or near airtight sealing of the doors 710-712 to prevent intrusion of moisture into the chamber of the kiln system 700 during drying operations.

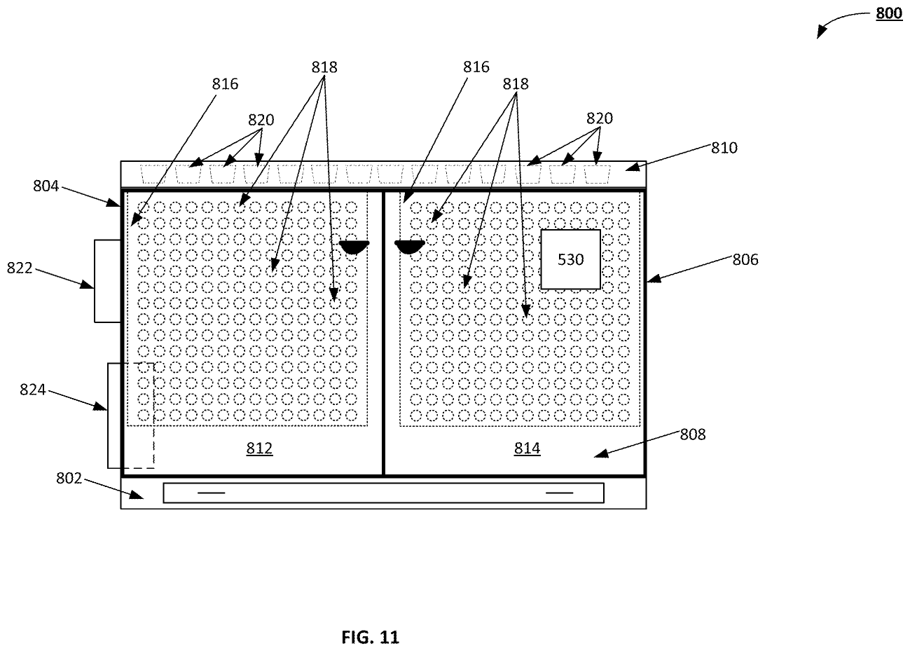

Referring now to FIG. 11, there is shown a kiln system 800 in accordance with another embodiment of the subject application. It will be appreciated that the kiln system 800 shown in FIG. 11 is substantially similar to the kiln system 700 described above with respect to FIG. 10. That is, the kiln system 800 includes a base component 802, opposing first and second side panels 804 and 806, a rear panel 808, a top cover/panel 810, and first and second doors 812 and 814. In the embodiment of FIG. 11, the heating components (not shown) may be positioned within the base component 802 or adjacent to the rear panel 808. Ducting (not shown) may be implemented to direct heated air through heated air panels 816 formed on or attached to the rear panel 808. As illustrated in FIG. 11, each of the heated air panels 816 include one or more vents 818 configured to allow passage of heated air through the panels and into the interior of the kiln system 800 to effectuate drying (and/or treating).

In the embodiment shown in FIG. 11, the top panel 810 may include one or more heat lamps 820 configured to radiate heat down into the interior of the kiln system 800 in addition to or in place of the heat air depending upon the stage of drying of the material placed therein. The heat lamps 820 may be embedded in or removably attached, e.g., screwed into Edison-type sockets, removable electrical connectors, etc., to the top panel 810, as shown in FIG. 11. An inverter 822, positioned on an exterior surface of the kiln system 800, e.g., affixed to the first side panel 804, is configured to convert incoming voltage to the voltage and current type of the selected heat lamps 820. The kiln system 800 further includes a dehumidifier component 824, positioned on an exterior surface of the kiln system 800, e.g., the first panel 804, with access via a duct or passageway to the interior of the kiln system 800 to effectuate the removal of moisture therein. It will be appreciated that the heat lamps 820 and dehumidifier 824 are optional components of the kiln system 800, and use thereof may be dependent upon the type of material being dried, the moisture content thereof, and myriad other factors as will be appreciated by the skilled artisan. In other embodiments, a desiccant, such as a removable bag or canister, may be used in place of or in addition to the dehumidifier 824. In such embodiments, the removable bag or canister may be refillable or reusable, and function to absorb/remove moisture from within the kiln system 800.

In the illustration of FIG. 11, the controller 530 is suitably affixed to at least one of the first and second doors 812 or 814, and configured to control operations of the kiln system 800 to effectuate the drying (or treatment) of the materials placed therein. As referenced above, operations of the controller 530 and the drying process are discussed in greater detail below with respect to FIG. 23.

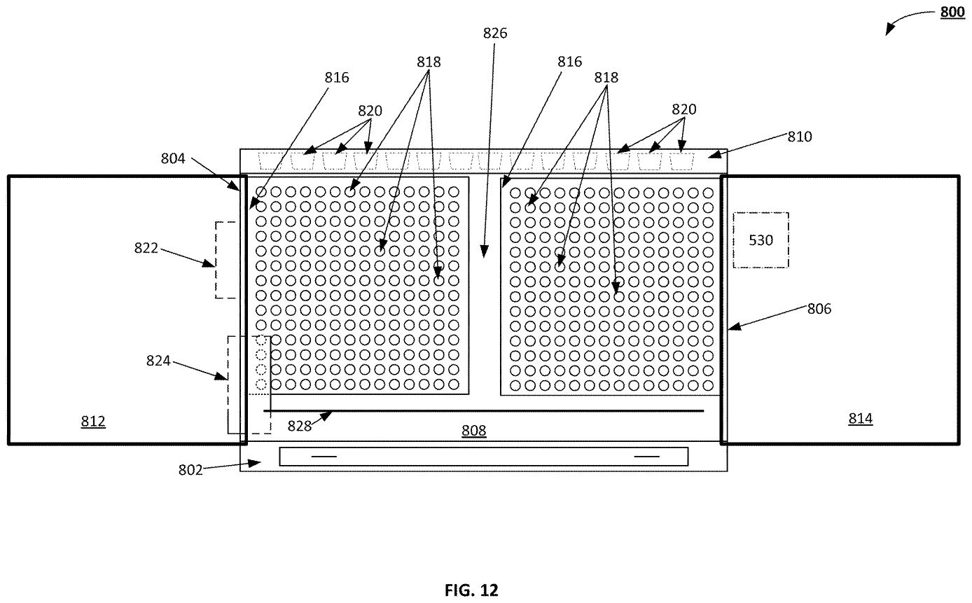

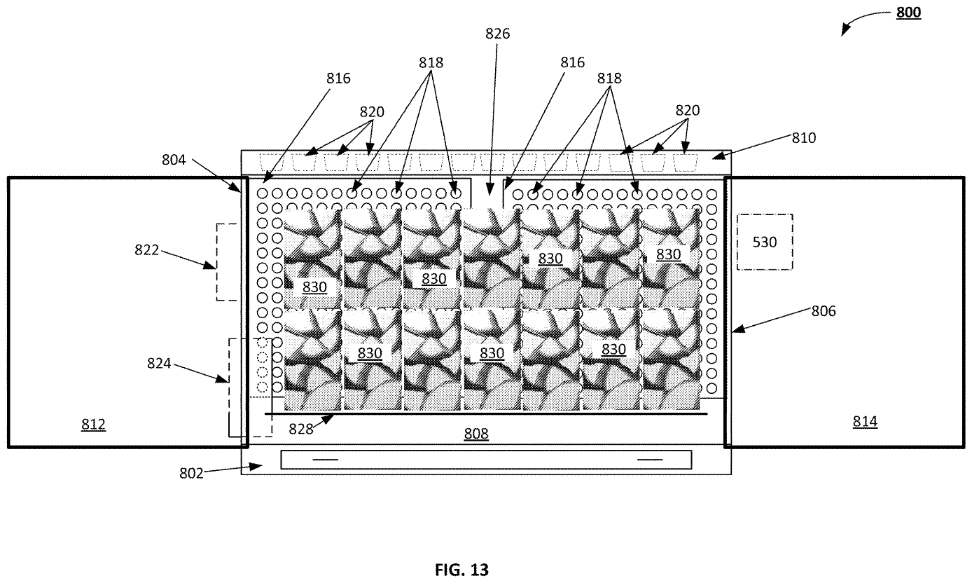

FIG. 12 provides another view of the kiln system 800 of FIG. 11, where the doors 812 and 814 are opened. As depicted in FIG. 12, the interior portion or drying chamber 826 of the kiln system 800 is visible. The drying chamber 826 includes at least one shelf 828 configured to support the material being dried. FIG. 13 provides an illustration of the kiln system 800 loaded with wood logs 830 for drying during operations of the kiln system 800 in accordance with some embodiments.

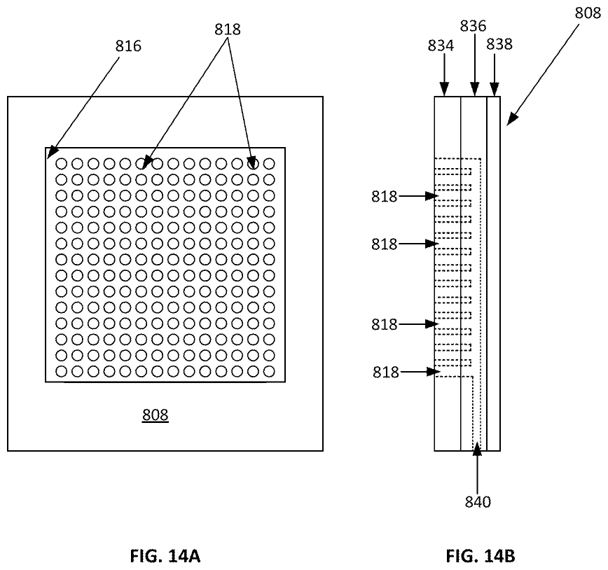

FIGS. 14A and 14B show respective front and side views of the rear panel 808 including a heated air panel 816 in accordance with some embodiments of the subject application. As shown in FIG. 14B, the rear panel 808 may be a multi-layered construction, including a heat-resistant inner portion 834 facing the drying chamber 826, one or more insulated layers 836, and an exterior portion 838. As illustrated, the one or more vents 818 of the heated air panels 816 extend through the heat-resistant inner portion 834 to fluidically attach to a duct 840 extending perpendicularly from the base component 802 through the one or more insulated layers 836, enabling heated air to flow out the one or more vents 818 into the chamber 826.

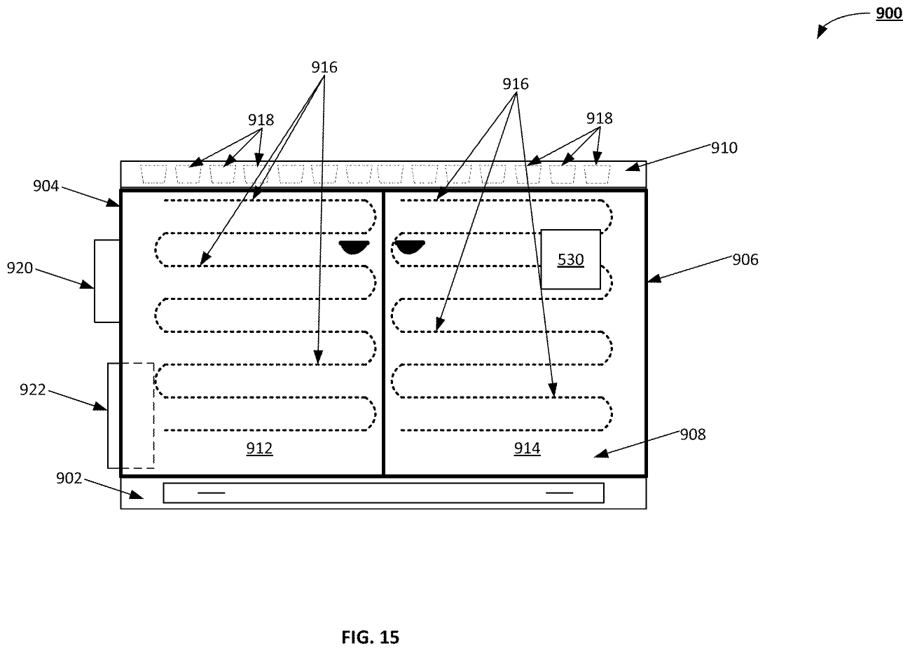

Referring now to FIG. 15, there is shown a kiln system 900 in accordance with another embodiment of the subject application. It will be appreciated that the kiln system 900 shown in FIG. 15 is substantially similar to the kiln systems 700 and 800 respectively described above regarding FIG. 10 and FIG. 11. That is, the kiln system 900 includes a base component 902, opposing first and second side panels 904 and 906, a rear panel 908, a top cover/panel 910, and first and second doors 912 and 914. In the embodiment of FIG. 15, the heating components are radiant heating elements 916 positioned on or within the base component 902, the first or second opposing side panels 904 and 906, or the rear panel 908. Such radiant heating elements may be, for example and without limitation, resistive heating elements or fluidically supplied heating elements, as will be appreciated by the skilled artisan. Piping (fluid) and wires (resistive) (not shown) may be implemented to supply heated fluid or electrical power, respectively, to the radiant heating elements 916. In some other embodiments, the radiant heating elements 916 may be formed in or on (or near) one or more racks or shelves on which wood or other material is placed. In some embodiments, the radiant heating elements 916 are positioned in proximity to the one or more racks or shelves.

In the embodiment shown in FIG. 15, the top panel 910 may include one or more heat lamps 918 configured to radiate heat down into the interior of the kiln system 900 in addition to or in place of the heat air depending upon the stage of drying of the material placed therein. The heat lamps 918 may be embedded in or removably attached, e.g., screwed into Edison-type sockets, removable electrical connectors, etc., to the top panel 910, as shown in FIG. 15. An inverter 920, positioned on an exterior surface of the kiln system 900, e.g., affixed to the first side panel 904, is configured to convert incoming voltage to the voltage and current type of the selected heat lamps 918 and/or the radiant heating elements 916. The kiln system 900 further includes a dehumidifier component 922, positioned on an exterior surface of the kiln system 900, e.g., the first panel 904, with access via a duct or passageway to the interior of the kiln system 900 to effectuate the removal of moisture therein. It will be appreciated that the heat lamps 918 and dehumidifier 922 are optional components of the kiln system 900, and use thereof may be dependent upon the type of material being dried, the moisture content thereof, and myriad other factors as will be appreciated by the skilled artisan.

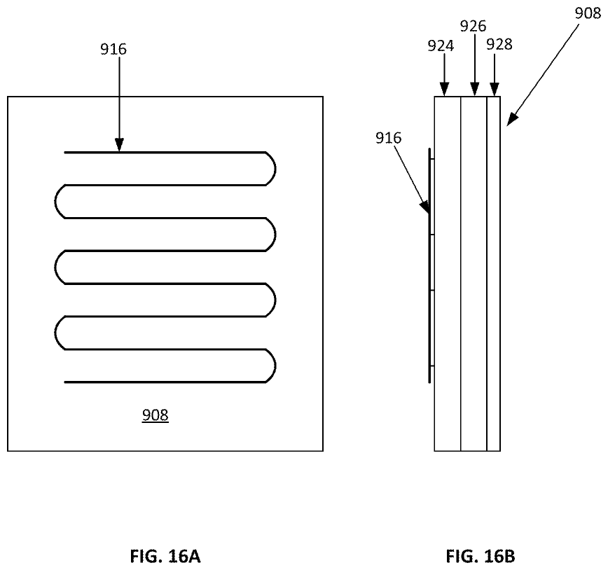

In the illustration of FIG. 15, the controller 530 is suitably affixed to at least one of the first and second doors 912 or 914, and configured to control operations of the kiln system 900 to effectuate the drying of the materials placed therein. As referenced above, operations of the controller 530 and the drying process are discussed in greater detail below with respect to FIG. 23. FIGS. 16A and 16B show respective front and side views of the rear panel 908 including a radiant heating element 916 in accordance with some embodiments of the subject application. As shown in FIG. 16B, the rear panel 908 may be a multi-layered construction, including a heat-resistant inner portion 924 facing the drying chamber, one or more insulated layers 926, and an exterior portion 928. As illustrated, the radiant heating elements 916 are positioned on the interior facing surface of the heat-resistant inner portion 924. It will be appreciated that internal or external power or fluid transfer (not shown) may be used to activate and heat the heating elements 916.

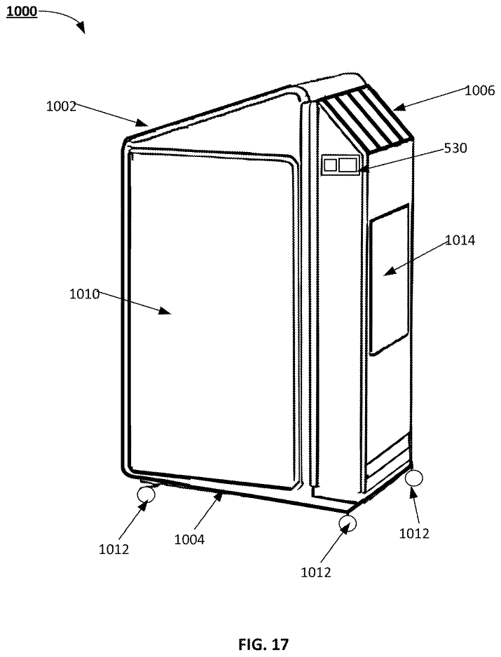

Turning now to FIG. 17, there is shown a drying cabinet, kiln, or kiln system 1000 in accordance with another embodiment of the subject disclosure. As shown in FIG. 17, the kiln system 1000 includes a cabinet component 1002, a movable base component 1004, and a heat engine assembly 1006. Variations on the size of the kiln system 1000 are contemplated herein, and the illustration in FIG. 17 is intended as a non-limiting example. The kiln system 1000 may be configured to have dimensions commensurate with residential, industrial, or commercial applications. The illustration in FIG. 17 of a residential version of the kiln system 1000 may be implemented with, for example, exterior dimensions having a width in the range of 25 inches to 50 inches in width, 55 inches to 90 inches in height, and 20 inches to 40 inches in depth. The skilled artisan will appreciate that such ranges are intended solely to illustrate one possible implementation of the kiln system 1000 illustrated in FIG. 17, and other sizes and dimensions are contemplated herein.

The cabinet component 1002 includes a sealable flap or door 1010 configured to prevent the intrusion of moisture or the elements into the interior of the cabinet component 1002 where wood or other items are being dried. The base component 1004 includes one or more moving elements, shown in FIG. 17 as casters 1012, enabling movement of the kiln system 1000 in the x and y directions. The heat engine component 1006 shown in FIG. 17 includes a moisture separation membrane 1014 and the controller 530.

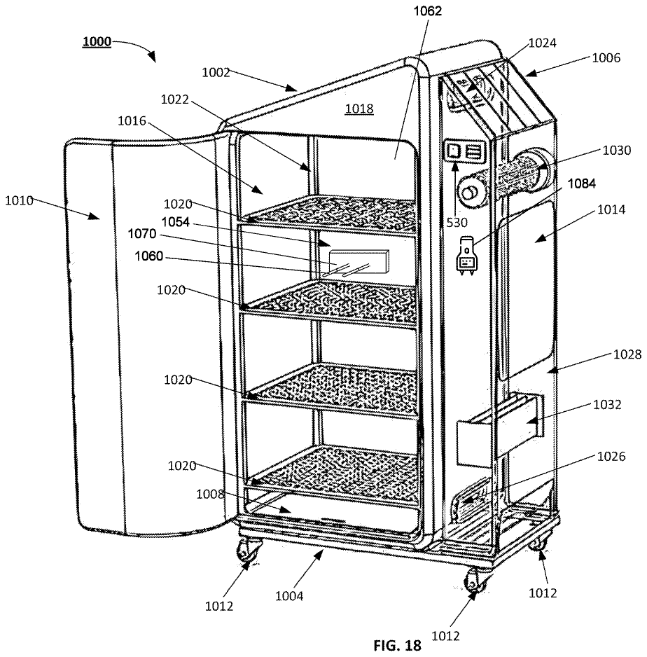

FIG. 18 provides another view of the kiln system 1000 of FIG. 17 in accordance with some embodiments. As shown in FIG. 18, the cabinet component 1002 includes a drying chamber 1016, accessible via the door 1010. In the embodiment of FIGS. 17-18, the cabinet component 1002 includes a flexible outer cover 1018 of the same or similar material as the door 1010. Located within the chamber 1016 of the cabinet component 1002 are one or more shelves or racks 1020 onto which wood or other material may be placed for drying. The terms “rack” and “shelf” are used interchangeably herein. In accordance with some embodiments, the shelves 1020 are configured with openings to allow circulation of air between the shelves 1020 during operations of the kiln system 1000. Suitable shelf or rack material may include, for example and without limitation, mesh or gratings of metal, metal-alloy, heat-resistant rigid plastics, fiberglass, or the like. In accordance with some embodiments, the racks or shelves 1020 may include radiant heating elements (not shown) to provide heat within the cabinet chamber 1016. In such embodiments, resistive or fluidic heating elements may be implemented adjacent to the shelves 1020, with power and/or fluid supplied by the heat engine assembly. In aspects, control of such radiant heating elements may be provided by the controller 530, a separate device, a switch, an internal or external power supply, or the like. Accordingly, the illustration of the kiln system 1000 in FIG. 17-18 is intended as one non-limiting example embodiment.

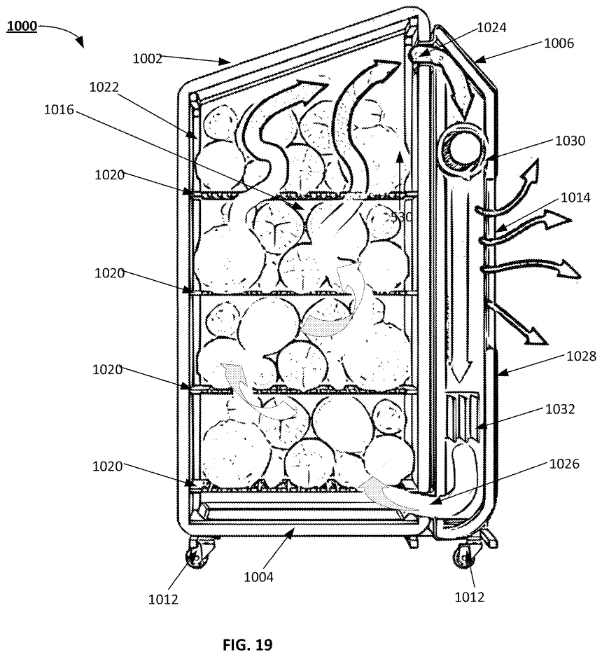

According to some embodiments, the cover 1018 is removably attached to a cabinet frame 1022, to which each shelf or rack 1020 may also be removably attached. The cabinet frame 1022 in combination with the cover 1018 provide a semi-rigid shape to the cabinet 1002, as illustrated in FIGS. 17-18. Further, it will be appreciated that the sloping of the top of the cabinet 1002 may provide one or more benefits to operations of the kiln system 1000. For example, the slope may facilitate the prevention of accumulation of precipitation, e.g., rain, snow, ice, sleet, etc., on the upper surface of the kiln system 1000 when the kiln system 1000 is stored and/or use outside a structure, e.g., cabin, home, store, building, etc. Additionally, the slope may facilitate the flow of air circulated inside the cabinet chamber 1016, as illustrated and discussed below with respect to FIG. 19.

In addition to the door 1010, the cabinet component 1002 includes one or more outlet ducts 1024 and one or more inlet ducts 1026 to enable circulation of air to and from the heat engine assembly 1006. It will be appreciated that while illustrated in FIG. 18 as having single inlet/outlet ducts 1024, 1026, the kiln system 1000 may be implemented with any number of such ducts 1024, 1026 to allow distribution and reclamation of heated air within the chamber 1016 by the heat engine assembly 1006. Accordingly, illustration of single inlet/outlet ducts 1024-1026 is intended solely as one non-limiting example thereof. As noted above, the door 1010 may include a seal and fastener (not shown) to allow for securing the door 1010 to the remainder of the cover 1018, thereby preventing the loss of heat during operations, as well as the ingress of unwanted moisture while the kiln system 1000 is operating.

The heat engine assembly 1006 shown in FIG. 18 is removably affixed to the base component 1004 and the cabinet component 1002. As illustrated in FIG. 18, the heat engine assembly 1006 may have an outer cover or housing 1028 of a rigid or semi-rigid material, e.g., metal, metal-alloy, dense plastic, etc. Within the housing 1028 of the heat engine assembly 1006 are a blower assembly 1030 and one or more heating elements 1032. As shown in FIG. 18, the blower assembly 1030 is positioned below the outlet duct 1024 of the cabinet component 1002 and is configured to pull air from the chamber 1016 and force such air down past the moisture separation membrane component 1014 to the heating elements 1032. The heating elements 1032, when active, heat the air flowing past as the air is forced into the chamber 1016 via the inlet duct 1026. The housing 1028 of the heat engine assembly 1006 includes a sloped roof, functioning similar to that of the cabinet component 1002, e.g., channeling the flow of air downward toward the blower assembly 1030 and preventing the accumulation of precipitation on the heat engine assembly 1006 when stored outside a protective structure, e.g., building. A controller 530 may be accessible on an exterior surface of the housing 1028 of the heat engine assembly 1006 and be configured to control operations of the kiln system 1000, as discussed below. FIG. 19 provides a graphical illustration of the circulation of air within the kiln system 1000, from the blower assembly 1030 past the membrane 1014 down to the heating elements 1032 through the inlet duct 1026, upwards over and around logs/wood and through the outlet duct 1024.

FIG. 20 provides a disassembled view of the kiln system 1000 of FIGS. 17-19. In FIG. 20, the aforementioned components described above are more readily visible. In particular, FIG. 20 provides a distinct illustration of the cabinet frame 1022 and shelves 1020 affixed thereto. Further, as illustrated in FIG. 20, a load sensor array 1034 is positioned between the frame 1022 and the base component 1004, configured to determine the weight of the material placed on the shelves 1020. Other sensors are also included, but not shown including, for example and without limitation, moisture sensors, temperature sensors (internal and/or external), airflow sensors, blower speed sensors, timing sensors and the like. As well, while specific sensor placement is shown, it is to be appreciated that the sensor(s) can be co-located or individually located without departing from the spirit and scope of the innovation described herein. A removable debris tray 1008 is also shown in FIG. 20, which may be placed on any of the shelves 1020, or be positioned below the lower-most shelf 1020. In accordance with one embodiment, a removable canister, bag, container, etc., that includes a suitable desiccant material may be positioned below the debris tray 1008, to facilitate removal of moisture from within the chamber 1016. In other embodiments, such a removable or replaceable desiccant material may be positioned within the heat engine assembly 1006 in place of or in addition to the membrane 1014.

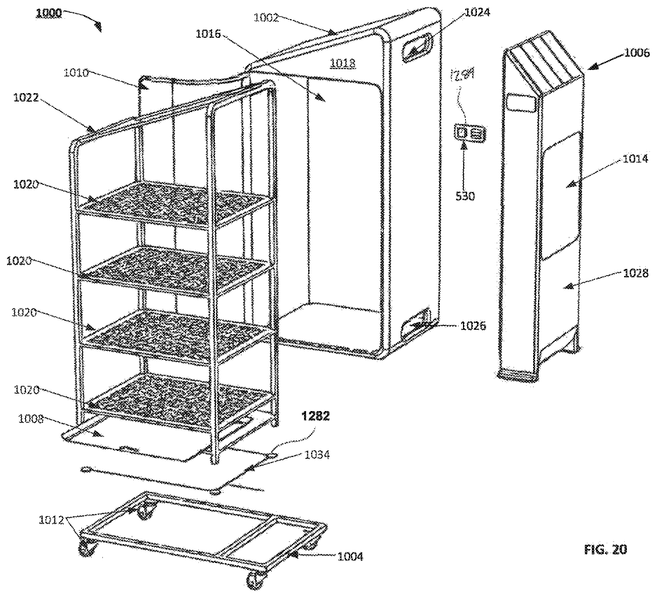

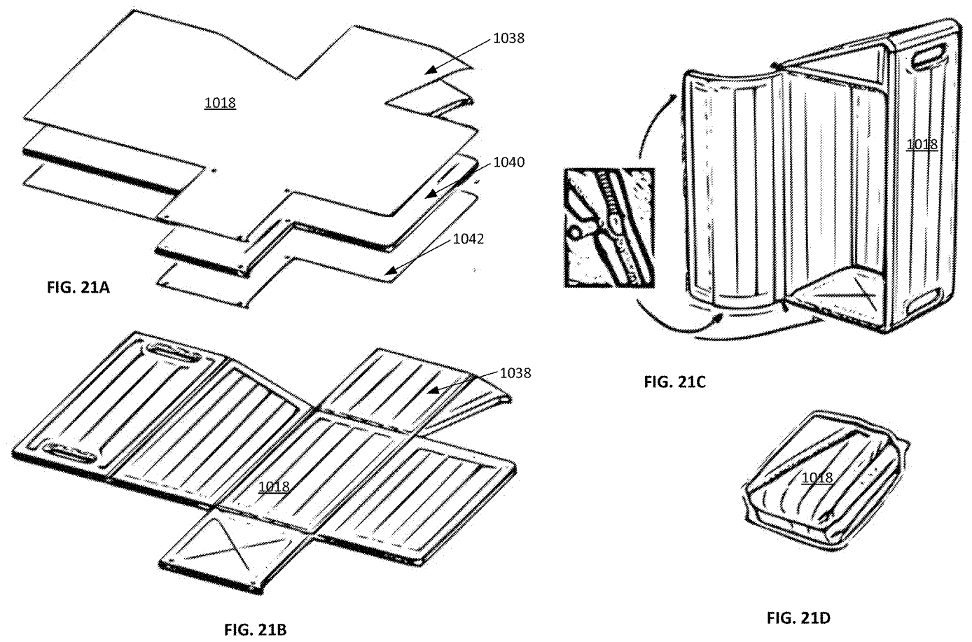

FIGS. 21A-21D provide an illustration of a flexible cover 1018 that is positioned over and around the cabinet frame 1022 in accordance with some embodiments. As shown in FIGS. 21A-21D, the cover 1018 may be constructed of three plies of different material, however it will be appreciated that the illustration in FIGS. 21A-21D is intended as an example embodiment, and single plies, double-ply, and plies in excess of three are also contemplated herein. Continuing with the non-limiting example of FIGS. 21A-21D, the outer layer 1038 may be constructed of a wear-resistant material, e.g., plastic, nylon, sailcloth, etc., whereas the interior or middle layer 1040 includes an insulating material, e.g., an R-15 or better rated material, and the third or innermost layer 1042 including a wear and heat-resistant material. The multiple layers 1038-1042 may be sewn, welded, or otherwise attached to form the cover 1018, as will be appreciated. The cover 1018 may be formed into the cabinet 1002, as shown in FIG. 21C via zipper or other type of fasteners, or folded (FIG. 21D) for packaging, transport, or storage.

Turning now to FIGS. 22A-22B, there is shown yet another example of the kiln system 1000 in accordance with one embodiment. The kiln system 1000 shown in FIGS. 22A-22B is identical to that of FIGS. 17-21D, however the cover 1018 has been modified to remove the zipper fasteners, and instead a plurality of magnetic fasteners 1044 are selectively attached to the cover 1018, thereby enabling secure sealing of the door 1010 to the cover 1018. A door frame 1046 is also utilized in this example embodiment to provide additional structural support to the door 1010. As illustrated in FIGS. 22A-22B a portion of the magnetic fasteners 1044 may be affixed to flaps 1048 and 1050, thereby providing additional security of the door 1010 to the cover 1018. Such magnetic fasteners 1044 may include a pair of magnets and steel or other ferrous metal/metal alloy.

Referring back to FIG. 18, in some embodiments the kiln system 1000 includes a first moisture probe 1054 configured to directly measure the moisture content of wood within the drying chamber 1016. In embodiments, the first moisture probe 1054 is a resistance type probe that includes at least two electrically conductive pins 1060 that protrude from an interior surface of the cabinet component 1002, at a rear wall 1062 of the drying chamber 1016 opposite the door 1010. With this construction, when the user loads wood onto the shelves or racks 1020 and against the rear wall 1062, the pins 1060 penetrate or press into the wood. The first moisture probe 1054 measures the electrical resistance between the pins 1060, which varies as a function of moisture content of the wood, and provides the measured resistance or a derived moisture content value to the controller 530.

In embodiments, each pin 1060 is individually biased from the rear wall 1062 by a corresponding spring element 1064, such as a compression spring, a leaf spring, or an elastomeric biasing member, disposed between the pin 1060 and a base 1070 mounted on the rear wall 1062. Because the resistance measurement is sensitive to contact pressure, individually biasing the pins 1060 causes each of the pins 1060 to exert substantially equal contact force against the wood irrespective of surface irregularities such as bark, knots, splits, or curvature. In additional or alternative embodiments, the base 1070 may be a pivoting member, such as a hinged plate or a cantilevered arm biased toward the wood by a spring or other resilient element. With this construction, the base 1070 may automatically adjust and angular orientation of the pins 1060 responsive to the wood surface, equalizing contact pressure across the pins 1060 without requiring the user to manually orient the wood.

Referring now to FIG. 22A, the door 1010 is coupled to the cabinet frame 1022 by hinges 1072, and a pressure assembly 1074 is disposed on an interior side of the door 1010, at a side of the door 1010 closer to the hinges 1072 than to an opposite free end 1080 of the door 1010. The pressure assembly 1074 includes a plate 1082 mounted to the door 1010, and extends inward from the door 1010 toward the drying chamber 1016. With this construction, when a user closes the door 1010, the plate 1082 contacts the wood loaded on the shelves or racks 1020 and urges the wood against the rear wall 1062, pressing the wood into the pins 1060 of the first moisture probe 1054 and establishing reliable contact that facilitates moisture measurement.

While the plate 1082 is depicted as a flat surface that presses wood toward the first moisture probe 1054 at the rear wall 1062, the pressure assembly 1074 may additionally or alternatively include prongs or other gripping features that stabilize the wood as the wood is being pressed into the pins 1060 of the first moisture probe 1054 opposite the door 1010. Furthermore, in embodiments, the plate 1082 is spring mounted to the door 1010 such that the plate 1082 accommodates variations in wood size and shape with the pins 1060.

Positioning the pressure assembly 1074 proximate the hinges 1072, at a side of the door 1010 opposite the free end 1080, maximizes a mechanical leverage available to the user as the door 1010 pivots about the hinges 1072 during closing, allowing the user to exert minimal effort in guiding the firewood into contact with the pins 1060. In this manner, the pressure assembly 1074 ensures consistent contact between the pins 1060 and the wood during drying operations, enabling the controller 530 to obtain continuous or periodic moisture content readings without requiring the user to directly, manually press the wood against the pins 1060.

Referring back to FIG. 18, the kiln system 1000 includes a second moisture probe 1084 removably mounted on an exterior surface of the cabinet component 1002, vertically below the controller 530 and on a same exterior surface of the kiln system 1000 as the controller 530. The second moisture probe 1084 includes a probe body 1090 having pins 1092 that communicate moisture content data to the controller 530. In various embodiments, the second moisture probe 1084 may be operatively connected to the controller 530 wirelessly or by a flexible cable, such that the second moisture probe 1084 is tethered to the kiln system 1000 and movable within or about the drying chamber 1016 as permitted by a length of the flexible cable.

In operation, a user may remove the second moisture probe 1084 from the exterior of the kiln 1000, insert the pins 1092 into a selected location on the wood, for example at end grain or at a freshly split surface, and obtain a moisture content reading at that location. The user may reposition the second moisture probe 1084 to measure multiple pieces of wood without removing wood from the chamber 1016. In embodiments, the pins 1092 are each individually biased from the probe body 1090 by spring elements, and individually press into wood in a similar manner as the pins 1060 biased from the base 1070.

The controller 530 receives the moisture content data from the second moisture probe 1084 and may use that data in combination with or in place of data from the first moisture probe 1054 mounted on the rear wall 1062 to monitor drying progress and determine whether the wood has reached a target dryness condition. In this manner, the controller 530 receives the moisture content measurement from the first moisture probe 1054 or the second moisture probe 1084 and compares the moisture content measurement to a target moisture content threshold stored in the database 1138 or received via user input. The controller 530 may use the measurement to monitor drying progress and cease operation of the heating elements 1032 and the blower assembly 1030 upon reaching the target threshold. In embodiments, the controller 530 cross references the directly measured moisture content with weight data from the load sensor array 1034 to improve accuracy or calibrate the moisture estimate derived from weight measurements. The controller 530 may display the measured moisture content via the controller display or a remote device, and may issue an alert or notification upon determining that the wood has reached the target dryness condition.

In additional or alternative embodiments, one or both of the first moisture probe 1054 and the second moisture probe 1084 is a capacitive sensor that measures moisture content without penetrating contacted wood in the chamber 1016. In such embodiments, the capacitive sensor of the first moisture probe 1054 or the second moisture probe 1084 includes a sensor body having a substantially flat sensing surface that emits an electromagnetic field into material in contact with the sensing surface, measuring the dielectric response of that material, which varies as a function of moisture content. In embodiments, the capacitive sensor of the first moisture probe 1054 or the second moisture probe 1084 is disposed on a floor surface of the shelves or racks 1020 such that wood loaded onto the shelves or racks 1020 rests directly on the sensing surface, establishing contact for moisture measurement as the wood is loaded without requiring the user to separately position or orient the wood against the sensor. The flat sensing surface of the capacitive sensor may be complementary to cut or wedged surfaces of wood, providing an improved contact interface between the first moisture probe 1054 and the second moisture probe 1084 during drying operations of the kiln system 1000.

Turning now to FIG. 23, there is shown an example diagram of the controller 530 in accordance with some embodiments. It will be appreciated that while reference is made hereinafter to actions and operations of the system 1000, the controller 530 as described below is operative to control operations of any of the embodiments described above, and the discussion with respect to the system 1000 is not intended as limiting such operations. As shown in FIG. 23, the controller 530, which is capable of implementing the methods set forth herein, includes a processor 1104, which performs an example method by execution of processing instructions 1106 that are stored in memory 1108 connected to the processor 1104, as well as controlling the overall operations of the kiln system 400, 500, 700, 800, 900, 1000. The various components of the controller 530 may be connected by a data/control bus 1102. The processor 1104 of the controller 530 may be in communication with an associated database 1138 via a suitable communications link 1128. A suitable communications link 1128 may include, for example, a switched telephone network, a wireless radio communications network, infrared, optical, or other suitable wired or wireless data communications. The database 1138 is capable of implementation on components of the controller 530, e.g., stored in local memory 1108, e.g., on hard drives, virtual drives, or the like, or on remote memory accessible to the controller 530. It will be appreciated that while depicted in FIG. 23 as a single device, the controller 530 may be representative of a cloud-based computing, e.g., distributed processing system, and the illustration of the controller 530 as a single device is intended solely as a non-limiting illustrative example.

The associated database 1138 is representative of any organized collections of data (e.g., wood types 1140, temperatures 1142, log size 1144, log shapes 1146, fan speeds 1148, moisture content 1150, drying programs 1152, etc.) used for one or more purposes. The skilled artisan will appreciate that such information may be updated via machine learning during operations of the subject system. Implementation of the associated database 1138 is capable of occurring on any mass storage device(s), for example, magnetic storage drives, a hard disk drive, optical storage devices, flash memory devices, or a suitable combination thereof. The associated database 1138 may be implemented as a component of the controller 530, e.g., resident in memory 1108, or the like. In one embodiment, the associated database 1138 may include data corresponding to burn rates, moisture thresholds, power requirements, etc.

The controller 530 may include one or more input/output (I/O) interface devices 1134 and 1136 for communicating with external devices. The I/O interface 1136 may communicate, via communications link 1124, with one or more of a display device 1130, for displaying information, such estimated destinations, and a user input device 1132, such as a keyboard or touch or writable screen, for inputting text, and/or a cursor control device, such as mouse, trackball, or the like, for communicating user input information and command selections to the processor 1104. The I/O interface 1134 may communicate with external devices such as a user device (e.g., a mobile communications device, IoT device, and the like), via the communications link 1124.

It will be appreciated that the controller 530 illustrated in FIG. 23 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network includes physical layers and transport layers, as illustrated by various conventional data transport mechanisms, such as, for example and without limitation, Token-Ring, Ethernet, or other wireless or wire-based data communication mechanisms. Furthermore, while depicted in FIG. 23 as a networked set of components, the controller 530 is capable of implementation on a stand-alone device.

The controller 530 may include one or more of a computer server, workstation, personal computer, cellular telephone, tablet computer, pager, combination thereof, or other computing device capable of executing instructions for performing the exemplary method.

According to one example embodiment, the controller 530 includes hardware, software, and/or any suitable combination thereof, configured to interact with an associated user, a networked device, networked storage, remote devices, or the like.

The memory 1108 illustrated in FIG. 23 as a component of the controller 530 may represent any type of non-transitory computer readable medium such as random access memory (RAM), read only memory (ROM), magnetic disk or tape, optical disk, flash memory, or holographic memory. In one embodiment, the memory 1108 includes a combination of random access memory and read only memory. In some embodiments, the processor 1104 and memory 1108 may be combined in a single chip. The network interface(s) 1134, 1136 allow the computer to communicate with other devices via a computer network, (e.g., the Internet), and may include a modulator/demodulator (MODEM). Memory 1108 may store data processed in the method as well as the instructions for performing the exemplary method.

The digital processor 1104 can be variously embodied, such as by a single core processor, a dual core processor (or more generally by a multiple core processor), a digital processor and cooperating math coprocessor, a digital controller, or the like. The digital processor 1104, in addition to controlling the operation of the controller 530, executes instructions 1106 stored in memory 1108 for performing the method set forth hereinafter.

As shown in FIG. 23, the instructions 1106 stored in memory 1108 may include a material identification component 1110, configured to identify a type of material, e.g., wood, metal, plastic, cloth, etc., placed in the chamber 1016. In some embodiments, the material identification component 1110 may be configured to receive the identification of the material via user interaction with the system controller 530, e.g., input devices 1130, 1132, mobile phone, app, etc., or to automatically identify such material based upon weight, moisture content, image recognition, or the like. In such an automatic identification, additional sensors (not shown) may be included in the kiln system 1000.

The instructions 1106 stored in memory 1108 may further include a dryness selection component 1112 that is configured to determine, in accordance with an output from the identification component 1110, a level of dryness of the material to which the material is to be processed. That is, for example and without limitation, when the material is identified as firewood (generally), the dryness selection component 1112 queries the database 1138 to determine a suitable moisture content 1150 associated therewith that will enable the firewood to be ready for burning in the least amount of time and using the least amount of energy to effectuate that level of moisture content. Additional identification information may correspond to the length of the log 1144, the width of the log, the shape of the log 1146, etc. Additionally, the instructions 1106 in memory 1108 may also include measurement component 1118, which is configured to receive various measurements from a variety of sensors of the system 1000. Such measurements may include, for example and without limitation, current temperature of the chamber 1016, current temperature of the material, exterior temperature where the system 1000 resides, weight of the material, current moisture content of the material, humidity within the chamber 1016, and the like.

The instructions 1106 stored in memory 1108 may further include a drying program selection component 1116 configured to analyze the measurement, identification, and dryness selection information and retrieve from the database 1138 or determine a drying program 1152 corresponding to the above information. In some embodiments, preselected drying programs 1152 may be stored in the database 1138 that include fan/blower speed(s) 1148, temperatures, cycle time, etc. In other embodiments, the drying program 1152 may be dynamically determined in real-time based upon the aforementioned information and the outputs of one or more sensors, as well as a user-selected drying time.

The instructions stored m memory further include an operations component 1118 configured to control operations of the heat engine assembly in accordance with the drying program or a dynamically selected level of dryness (e.g., desired moisture content in the material). In some embodiments, the operations component 1118 sends and receives information to and from the blower assembly 1030 and heating element 1032 to direct the flow of heated air into the chamber 1016. The operations component 1118 may also be configured to receive real-time measurements from the measurement component 1112 and alter or adjust the operations of the blower assembly 1030 and/or heating element 1032.

In some embodiments, the controller 530 may include instructions 1106 stored in memory 1108 that include a communications component 1120. In such embodiments, the communications component 1120 may be configured to communicate with one or more external, e.g., remote devices, receive instructions from such remote devices, and the like. According to some aspects, a mobile device running an app may remotely control operations of the kiln system 1000. For example, a user may, via the mobile device, send a remote command to the controller 530 via a computer network indicating that firewood will be needed by a certain time on a certain day. The communications component 1120 receives this information, and in conjunction with the other components 1110-1118 described above, facilitates operations of the kiln system 1000 such that the firewood will be ready for burning at the preselected time.

The method begins by inserting one or more pieces of green or wet wood, e.g., logs, boards, beams, slats, etc., onto one of the racks or shelves 1020. In some embodiments, the type of wood (e.g., hardwood, softwood, etc.) is input into the controller 530 via direct interface or via remote communication, e.g., a user device (e.g. mobile communications device). In other embodiments, the controller 530 automatically identifies the type of wood loaded into the chamber 1016, as discussed above.

According to some embodiments, a weight sensor 1034 is used to weigh the logs/wood placed in the shelves 1020 inside the chamber 1016 of the kiln system 1000 to ascertain an initial weight thereof. In other embodiments, for example, when green logs are to be dried for firewood, the type of log, e.g., quarter, eighth, half, as well as the length of the log or approximation thereof, is input into the controller 530 or mobile communication device. The controller 530 then determines a drying program 1152, e.g. temperature range, duration, air flow rate, etc., appropriate for drying the wood. An initial temperature of the wood is determined via suitable temperature sensors and the controller 530 activates the heating element 1032 and blower assembly 1030 to begin drying operations.

Heated airflow is generated by the heating element 1032 and blower 1030 and directed through one or more ducts 1026 into the drying chamber 1016. The air flow within the chamber 1016, according to some embodiments, flows from the bottom of the chamber 1016 towards the top, commensurate with normal convection of heated air. The air passes upwards through the wood to the exhaust or outlet duct 1024, which then recirculates the air through the heater/blower 1032/1030 towards the one or more ducts 1026. In some embodiments, as shown in FIG. 19, the recirculated air passes along a permeable membrane 1014 to remove water vapor (e.g., moisture), from the airflow prior to entry into the drying chamber 1016.

During these drying operations, sensors continually measure the chamber, including the contents and blower air for factors such as temperature, moisture content, weight, and/or the like. For example and without limitation, a humidity sensor may be placed in the heat engine assembly 1006, e.g., between the blower assembly 1030 and the heating element 1032, to determine a level of moisture in the recirculated air flowing through the system, enabling adjustments of the air flow, temperature, drying time, notification, etc., by the controller 530 or other suitable component associated with the system. The controller 530 receives this information and determines whether the wood has reached a predetermined level of dryness, e.g., ready for burning, ready for shaping, ready for construction, etc. In some embodiments, the controller 530 is configured to calculate a percentage of moisture in the firewood relative to a threshold value. When the threshold value is met, the wood is determined to be ready for burning. The aforementioned calculations may be accomplished via an initial moisture content measurement and then a determination of current moisture content based upon weight change from initial weighing to the current weighing. In other embodiments, moisture content is estimated based upon initial weight and a predetermined weight change is calculated such that upon the weight reaching that predetermined weight change, operations are terminated and the wood is determined to be sufficient for burning. It will be appreciated that the moisture content of burnable wood may range from 13% to 20%, and the controller 530 and system 1000 described herein may be configured to stop operations when the wood is within such a range resulting in little to no smoke upon burning.

Upon reaching the predetermined level of dryness, operations of the kiln system 1000 terminate. The controller 530 may then issue an audible and/or visual alert that the firewood is ready for burning. In other embodiments, the controller 530 may communicate with a remote device, e.g., mobile phone or other type of user device, indicating that the drying operation has completed.

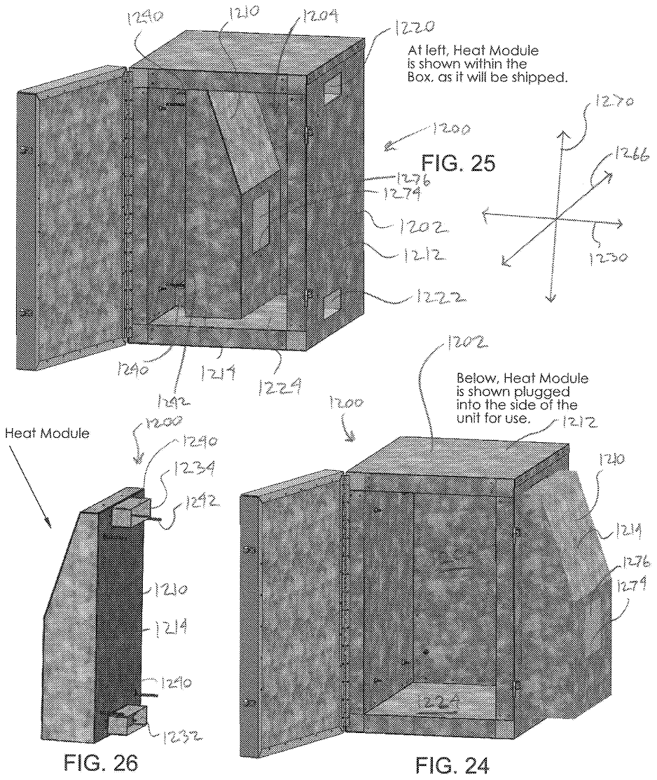

Turning to FIG. 24-26, additional embodiments of a kiln 1200 are illustrated in which a cabinet 1202 defines a chamber 1204 for receiving inventory to be dried, and a heat module 1210 may be fixed to an exterior 1212 of the cabinet 1202 during operation, and stored in the cabinet 1202 during shipping or transport. With reference to FIG. 24, the cabinet 1202 defines the chamber 1204 that receives inventory to be dried. The kiln 1200 further includes the heat module 1210. The heat module 1210 includes a housing 1214 fixed to the exterior 1212 of the cabinet 1202. In this manner, the heat module 1210 remains external to the chamber 1204 during operation while remaining removable from the cabinet 1202 for storage or shipment.

As shown in FIG. 25, the cabinet 1202 defines the chamber 1204, an inlet 1220 to the chamber 1204, and an outlet 1222 from the chamber 1204, which cooperate with the heat module 1210 during operation. More specifically, the inlet 1220 receives relatively hot, dry air from the heat module 1210 at or near a floorspace 1224 of the chamber 1204, and the outlet 1222 communicates relatively cool, humid air from an upper region of the chamber 1204 back to the heat module 1210. In this manner, airflow passes evenly and entirely over inventory positioned within the cabinet 1202 during a drying operation.

The heat module 1210 has an exterior footprint that is smaller than a horizontal cross-sectional area along the floorspace 1224 of the chamber 1204, and an exterior height that is smaller than a height of the chamber 1204. With this construction, at least a single instance of the heat module 1210 may be placed within the cabinet 1202 during storage or transport of the kiln 1200. Further, a length of the exterior footprint of the heat module 1210 in a first direction along the floorspace 1224, indicated by an arrow 1230, is less than half of a maximum distance of the horizontal cross-sectional area of the chamber 1204 in the first direction. With this construction, at least two heat modules may be fixed to the cabinet, as explained in greater detail below.

In this regard, in embodiments, the heat module 1210 described above is a first heat module, the inlet 1220 is a first inlet, and the outlet 1222 is a first outlet, the cabinet 1202 further defines a second inlet and a second outlet, and the kiln 1200 further includes a second heat module having similar features and functioning in a similar manner as the heat module 1210, at the second inlet and the second outlet of the cabinet 1202. In embodiments, the first heat module and the second heat module embody a same design, simplifying assembly of the kiln 1200 by an end user.

In further embodiments, the second inlet and the second outlet may be defined at a side of the cabinet 1202 opposite the inlet 1220 and the outlet 1222 in the first direction along the floorspace 1224. In such embodiments, the housing 1214 is a first housing defining a first interior, within which a first heating element and a first blower assembly are positioned, and the second heat module has a second housing fixed to the exterior 1212 of the cabinet 1202, where the second housing defines a second interior fluidly connected to the chamber 1204 through the second inlet and the second outlet. A second heating element may be positioned within the second interior, together with a second blower assembly, such that the second blower assembly directs airflow from the second heating element, through the second inlet, and toward the chamber 1204. In this manner, the second inlet, the second outlet, and the second heat module include similar features and function in a similar manner as the inlet 1220, the outlet 1222, and the heat module 1210 heating and circulating airflow with the chamber 1204.

In such embodiments, a length of the exterior footprint of each of the first heat module and the second heat module in the first direction along the floorspace 1224, indicated by the arrow 1230, may be equal to or less than half of a maximum distance of the horizontal cross-sectional area of the chamber 1204, along the floorspace 1224 in the first direction. With this construction, the first heat module and the second heat module have a combined exterior footprint that is smaller than the horizontal cross-sectional area of the chamber 1204, and have an exterior height that is smaller than a height of the chamber 1204, such that both the first heat module and the second heat module may be placed together within the chamber 1204 during storage or transport. During operation of the kiln 1200 the first heat module and the second heat module may be fixed to the exterior 1212 of the cabinet 1202 along the first direction for operation in drying inventory in the chamber 1204.

In various embodiments, the cabinet 1202 defines the size and shape of the chamber 1204 based on intended contents and corresponding use. In this regard, common firewood lengths include about 4-12 inches for compact appliances for quick burns such as chimineas, about 12-18 inches for fireplaces, about 16-18 inches for stoves, and about 18-24 inches for larger fireboxes or outdoor pits, with custom lengths up to about 30 inches used for larger applications.

For example and without limitation, when the inventory to be dried is firewood, the chamber 1204 may have a depth or width along the floorspace 1224, or an overall height that accommodates typical firewood lengths while maintaining uniform airflow across the inventory during operation. In a first example model, the cabinet 1202 defines the chamber 1204 with a usable depth, width, or height of 20-22 inches that accommodates logs having lengths of about 16-18 inches. With this construction the usable depth, width, or height is about 1-2 inches greater than a nominal log length in the inventory to permit clearance at the log ends for airflow between the inlet 1220 and the outlet 1222, including anticipated variation in user placement. In additional or alternative embodiments, the cabinet 1202 may define the chamber 1204 with a depth, width, or height of 20-28 inches, corresponding to inventory for larger fireboxes or outdoor pits. In other embodiments, smaller models are provided with a depth, width, or height of 6-14 inches, corresponding to inventory for compact appliances or quick burns. In further embodiments, configurations are provided with a depth, width, or height of 14-20 inches, corresponding to inventory for standard fireplaces. In yet other embodiments, custom configurations provide a depth, width, or height up to 32 inches, corresponding to inventory for larger applications. In each of the foregoing embodiments, the vertical circulation path spans substantially the full height of the chamber 1204. In some implementations, the cabinet 1202 may additionally or alternatively define the chamber 1204 with other custom dimensions that accommodate inventory with a predetermined clearance, promoting focused and unobstructed circulation during the drying operation.

In further embodiments, the cabinet 1202 defines the chamber 1204 with a depth corresponding to the usable log length and with a width or height less than that length, prompting a user to orient the wood along that direction. This configuration promotes even drying in the chamber 1204 and guides proper inventory placement in the chamber 1204, while maintaining relatively reduced external dimensions of the cabinet 1202 and kiln 1200 as a whole for shipping, storage, and use.

With continued reference to FIG. 25, the cabinet 1202 defines the inlet 1220 and the outlet 1222 through a same wall, at a same side of the chamber 1204 relative to the floorspace 1224 in the first direction, the inlet 1220 being spaced from the outlet 1222 by a first vertical distance. As shown in FIG. 26, the housing 1214 defines a first aperture 1232 in direct fluid communication with the inlet 1220, and defines a second aperture 1234 in direct fluid communication with the outlet 1222, the second aperture 1234 being spaced from the first aperture 1232 by a second vertical distance that is equal to the first vertical distance.

The heat module 1210 includes ducts 1240 that extend the first aperture 1232 and the second aperture 1234 from the housing 1214, and respectively into the inlet 1220 and the outlet 1222. In this regard, the inlet 1220 and the outlet 1222 respectively receive the ducts 1240 from the first aperture 1232 and the second aperture 1234, directly connecting the interior of the housing 1214 in fluid communication with the chamber 1204. The heat module 1210 also includes fasteners 1242 that fix the housing 1214 to the cabinet 1202, thereby maintaining the chamber 1204 in fluid communication with the interior of the housing 1214. While, as depicted, the fasteners 1242 may include bolts, in other embodiments the fasteners 1242 may include screws, threaded studs, rivets, clips, latches, clamps, cam locks, quarter-turn fasteners, or combinations thereof, suitable for fixing the heat module 1210 to the cabinet 1202 without departing from the scope of the present disclosure.

In this arrangement, the inlet 1220 and the outlet 1222 are spaced vertically across the chamber 1204, maximizing a circulating airflow path within the chamber 1204 and promoting circulation of airflow evenly across all or any inventory stored in the chamber 1204. At the same time, the heat module 1210 has a height that is shorter than a height of the cabinet 1202, which enables the heat module 1210 to be stored within the chamber 1204 during shipping or transport, as described above. In such embodiments, the first aperture 1232 and the second aperture 1234 are respectively located at or adjacent a bottom and a top of the housing 1214, such that the heat module 1210 spans at least most of the height of the chamber 1204 when coupled to the cabinet 1202. In this manner, airflow is directed across substantially an entire height of the chamber 1204, facilitating even circulation of airflow over inventory stored therein. In such embodiments, a length of the first vertical distance is at least 90 percent of the height of the chamber 1204, further facilitating the advantageous airflow described above.

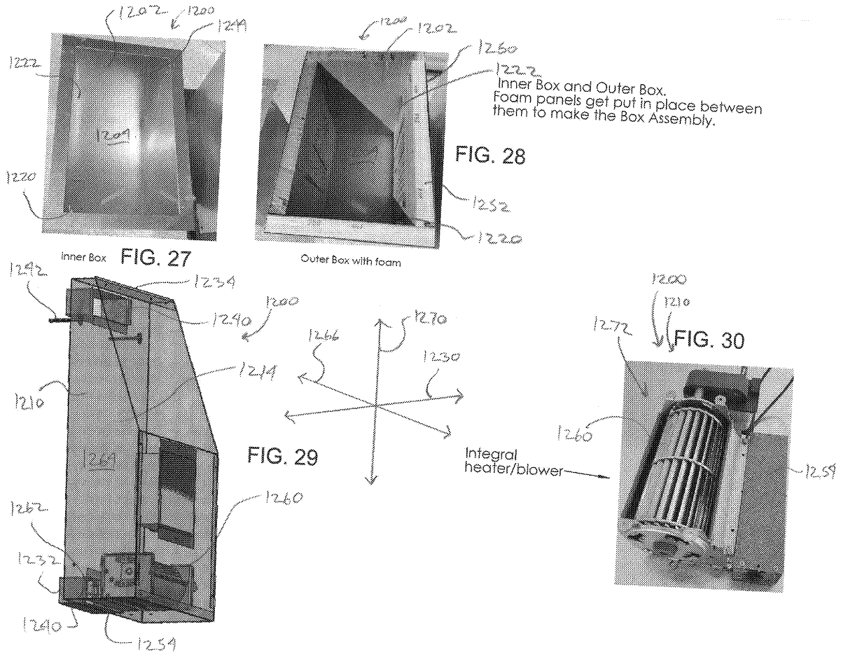

As shown in FIG. 27, the cabinet 1202 includes an inner box 1244 formed from a rigid panel structure that defines the chamber 1204. As shown in FIG. 28, the cabinet 1202 further includes an outer box 1250 that, when assembled, receives the inner box 1244 with an insulating material 1252 disposed between the inner box 1244 and the outer box 1250. In embodiments, the insulating material 1252 may include foam panels, rigid foam boards, spray-applied foam, mineral wool, fiberglass insulation, or combinations thereof, reducing heat loss from the chamber 1204 while maintaining structural rigidity of the cabinet 1202 at temperature ranges suitable for curing or drying various materials that may form the inventory. In this regard, the inventory may include wood, clay, ceramics, or a variety of other moisture-containing materials such as elastomeric materials, polymeric materials, or agricultural products. Such materials may have associated drying or curing temperatures including, for example and without limitation, temperatures on the order of about 80 °F to about 250 °F for wood and agricultural products, about 150 °F to about 400 °F for clay-based or ceramic materials, and about 120 °F to about 350 °F for polymeric, composite, or elastomeric materials.

As shown in FIGS. 27 and 28, the cabinet 1202 is a box having rigid walls that enclose the chamber 1204 and define the inlet 1220 and the outlet 1222. In such embodiments, the outer box 1250 forming the cabinet 1202 may have a minimum length, height, or width of 90 inches and a maximum length, height, or width of 110 inches. Alternatively, or in addition, the outer box 1250 may have a minimum combined length and girth of 145 inches and a maximum combined length and girth of 170 inches. In further embodiments, the outer box 1250 has a maximum combined length and girth of 130 inches, with a maximum height of 35 inches. In further embodiments, the outer box 1250 has a maximum combined length and girth of 110 inches, with a maximum height of 30 inches. With this construction, when the heat module 1210 is stored within the cabinet 1202, the kiln 1200 has overall external dimensions that fall within size limits commonly accepted by conventional shipping carriers, facilitating convenient transport and delivery of the kiln 1200 to end users, optionally through a supply chain network including intermediate storage facilities, while maximizing usable chamber volume for drying inventory and maintaining the inlet 1220 and outlet 1222 spacing for uniform airflow.

FIG. 29 is a partial perspective view of the heat module 1210, including a blower assembly 1254 and a heating element 1260 fixed at a floor 1262 of the housing 1214. As shown in FIG. 29, the interior 1264 of the housing 1214 is fluidly connected to the chamber 1204 through the inlet 1220 and the outlet 1222. The heating element 1260 is positioned within the interior 1264, and the blower assembly 1254 is also positioned within the interior 1264. In operation, the blower assembly 1254 directs airflow from the heating element 1260, through the inlet 1220, and toward the chamber 1204.

As shown in FIG. 25, a length of an exterior footprint of the heat module 1210 in a second direction along the floorspace 1224, orthogonal to the first direction and indicated by arrow 1266, is greater than half of a maximum distance of a horizontal cross-sectional area of the chamber 1204 in the second direction. The first direction and the second direction are each orthogonal to a third direction, indicated by arrow 1270, the third direction being a vertical direction when the kiln 1200 is in an upright position on horizontal ground. In this manner, as shown in FIG. 29, the interior 1264 defines empty space within the chamber 1204, around the blower assembly 1254 and the heating element 1260, facilitating airflow around the blower assembly 1254 and the heating element 1260 during operation.

As shown in FIG. 30, the heating element 1260 and the blower assembly 1254 are integrally fixed together as a single heater blower unit 1272. In this embodiment, the blower assembly 1254 includes a tangential blower that generates a substantially uniform airflow along an entire length of the inlet 1220, and the heating element 1260 includes an electric resistance heater positioned to transfer heat directly to the airflow produced by the blower assembly 1254. By integrating the heating element 1260 and the blower assembly 1254 into the heater blower unit 1272, the heat module 1210 achieves compact packaging and uniform heated airflow delivery to the chamber 1204, while simplifying assembly and installation of the heat module 1210 after delivery or storage.

As shown in FIG. 31, the housing 1214 defines a vent 1274 to ambient atmosphere and includes a moisture separation membrane 1276 disposed across the vent 1274. The moisture separation membrane 1276 covers an entire cross-sectional area of the vent 1274 such that all fluid flow through the vent 1274 passes through the moisture separation membrane 1276, and the moisture separation membrane 1276 is semipermeable to water vapor exiting the interior 1264 through the vent 1274. In this manner, the heat module 1210 defines the vent 1274 to ambient atmosphere through the moisture separation membrane 1276.

The moisture separation membrane 1276 is formed from at least one of a fibrous mineral, a coated fabric, a fibrous ceramic, a microporous polymeric material, or a combination thereof that forms a semipermeable filter allowing water vapor to exit the vent 1274, while otherwise restricting airflow to ambient atmosphere from the kiln 1200. More specifically, in various embodiments the moisture separation membrane 1276 may be formed from at least one of rockwool, expanded polytetrafluoroethylene, or fiberglass. With this construction, the moisture separation membrane 1276 is semipermeable, allowing passage of water vapor while otherwise restricting bulk airflow through the vent 1274, and further tolerates temperature ranges suitable for curing or drying inventory within the chamber 1204.

The moisture separation membrane 1276 is fixed at the vent 1274 between a vent strap and a wire mesh, forming an incongruity along the housing 1214 within the interior 1264, at a side of the housing 1214 opposite the cabinet 1202. With this construction, airflow directed across the housing 1214 in the first direction from the outlet 1222 is deflected downward along a duct cover 1280 forming the housing 1214, toward the incongruity along the housing 1214, where the moisture separation membrane 1276 directly abuts the airflow and separates water vapor from the airflow. The duct cover 1280 is angled downward from the top of the housing 1214, toward the vent 1274, facilitating airflow to the moisture separation membrane 1276 from the inlet 1220 with reduced energy loss.

While, as depicted, the housing 1214 defines the vent 1274 at a side of the heat module 1210 opposite the cabinet 1202, in other embodiments the housing 1214 may define the vent 1274 in a variety of locations. Additionally, or alternatively, the cabinet 1202 may define the vent 1274 to ambient atmosphere and include the moisture separation membrane 1276 disposed across the vent 1274, without departing from the scope of the present disclosure.

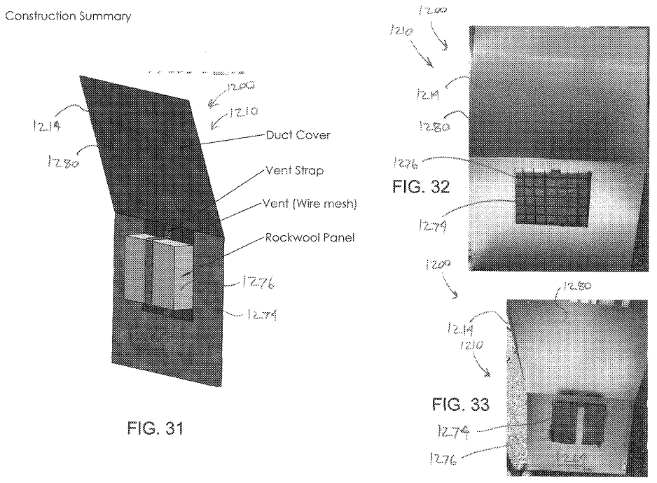

FIGS. 32 and 33 respectively depict an exterior view and an interior view of the duct cover forming a portion of the housing 1214, including the vent 1274 and the moisture separation membrane 1276 disposed at the vent 1274, with FIG. 32 illustrating the vent 1274 as viewed from outside the housing 1214 and FIG. 33 illustrating the moisture separation membrane 1276 as supported within the housing 1214 behind the vent 1274.

Referring back to FIG. 25, the housing 1214 defines the vent 1274 at a side of the housing 1214 opposite the cabinet 1202, with the vent 1274 spaced between the inlet 1220 and the outlet 1222 in a vertical direction. More specifically, the vent 1274 is located above the heating element 1260 and the inlet 1220, and located below the outlet 1222. With this arrangement, airflow within the chamber 1204 follows a vertical circulation path that extends across substantially the full height of the chamber 1204, promoting even airflow distribution over inventory stored therein while facilitating removal of moisture-laden air through the vent 1274, as described above with respect to earlier embodiments. In addition, positioning the vent 1274 between the inlet 1220 and the outlet 1222 causes moisture to be preferentially removed from airflow through the housing 1214 prior to recirculation through the heating element 1260, avoiding heat energy loss to exiting water vapor, and focusing heat energy into relatively drier air returned to the chamber 1204.

Referring back to FIG. 20, the load sensor array 1034 includes at least one sensor 1282 that may be incorporated in the kiln 1200 of FIG. 25, where the sensor 1282 measures a weight of the cabinet 1202, including inventory stored in the cabinet 1202. In such embodiments, the kiln 1200 may further include the base component 1004 as a base that supports the cabinet 1202, and the sensor 1282 may be a load cell disposed on the base component 1004, underneath the cabinet 1202. With this construction, changes in weight of the cabinet 1202, including any inventory stored in the chamber 1204, are directly measured by the load sensor array 1034 during operation of the kiln 1200.

The controller 530 may be operatively connected to the heating element 1260, the blower assembly 1254, and the sensor 1282 for controlling the kiln 1200 through a predetermined drying or curing operation. In this regard, the controller 530 may determine a moisture content or a weight loss rate of inventory in the chamber 1204 based on measured weights of the cabinet 1202 by the sensor 1282 over time. When the determined moisture content or the weight loss rate falls below a predetermined threshold, the controller 530 ceases operation of at least one of the heating element 1260 or the blower assembly 1254, ending the predetermined drying or curing operation.

In embodiments, a user interface 1284 is operatively connected to the controller 530. The user interface 1284 displays or communicates instructions and operational information, and receives user input for operation of the kiln 1200. In embodiments, the controller 530 and the user interface 1284 are fixed with the housing 1214, such that powered components of the kiln 1200 may each be located with the heat module 1210, and the cabinet 1202 is a passive enclosure. This arrangement simplifies manufacture and assembly of the cabinet 1202, since assembly of the kiln 1200 does not require electrical hookups between the cabinet 1202 and the heat module 1210, as electrical, control, and heating subassemblies may provided as a fully assembled unit fixable in the housing 1214.

With continued reference to FIGS. 20 and 25, the controller 530 executes predetermined drying or curing operations based on control parameters associated with an intended use of inventory provided in the chamber 1204. In this regard, the controller 530 sets the predetermined threshold for the determined moisture content or weight loss rate based on input received at the user interface 1284, where the input directly conveys a type and an intended use of the inventory. In this regard, the input received at the user interface 1284 may indicate, for example and without limitation, that the inventory includes wood intended for burning, wood intended for carving, ceramic material intended for curing, or clay intended for drying. The controller 530 may determine a target dryness of the inventory and may further select associated operating parameters including one or more of temperature ranges, airflow rates, or operation durations based on the input received at the user interface 1284.

In embodiments, the controller 530 grades the inventory based on the determined moisture content or weight loss rate relative to the predetermined threshold, and displays the grade at the user interface 1284. In embodiments, the controller 530 grades the inventory based on the determined moisture content or weight loss rate relative to the predetermined threshold, and displays the grade at the user interface 1284. In this regard, the controller 530 compares one or more target performance metrics, including weight loss rate or overall weight loss associated with the intended use of the inventory, to measured values obtained from the sensor 1282 and determined by the controller 530 during operation. The comparison performed by the controller 530 translates to a grade indicating a real-time readiness of the inventory for its intended purpose.

The user interface 1284 may display a variety of binary or graduated grading schemes without departing from the scope of the present disclosure. In this regard, the user interface 1284 may display, for example and without limitation, a simple on/off indicator indicating whether the inventory is ready for removal, a timer indicating time elapsed or time remaining until completion of a current kiln operation, a color-based or letter-based grading system that intuitively communicates readiness on a marginal scale, or a real-time indication of a determined moisture content or weight loss rate relative to the intended use of the inventory.

With continued reference to FIGS. 20 and 25, in embodiments, the controller 530 determines the moisture content or the weight loss rate of the inventory based on a difference between an initial weight measurement obtained by the sensor 1282 and a subsequent weight measurement obtained by the sensor 1282, together with an amount of time elapsed between the initial weight measurement and the subsequent weight measurement. In further embodiments, the controller 530 additionally or alternatively operates in one or more selectable modes in which drying progress is evaluated based on absolute weight loss, rate of weight loss over time, or stabilization of weight change over a defined interval. In such embodiments, the controller 530 may identify completion of a drying or curing operation when a rate of weight loss falls below a threshold for a sustained period of time, indicating that the inventory has reached a target dryness condition associated with the intended use of the inventory.

In embodiments, the controller 530 establishes the initial weight measurement by zeroing or taring the sensor 1282 after the inventory is placed within the chamber 1204 and prior to initiation of a drying or curing operation. In this manner, the initial weight measurement isolates a total weight of the inventory from a tare weight of the cabinet 1202 and associated structural components. Subsequent weight measurements obtained by the sensor 1282 may be compared to the initial weight measurement to determine changes in weight attributable to moisture loss from the inventory during operation of the kiln 1200.

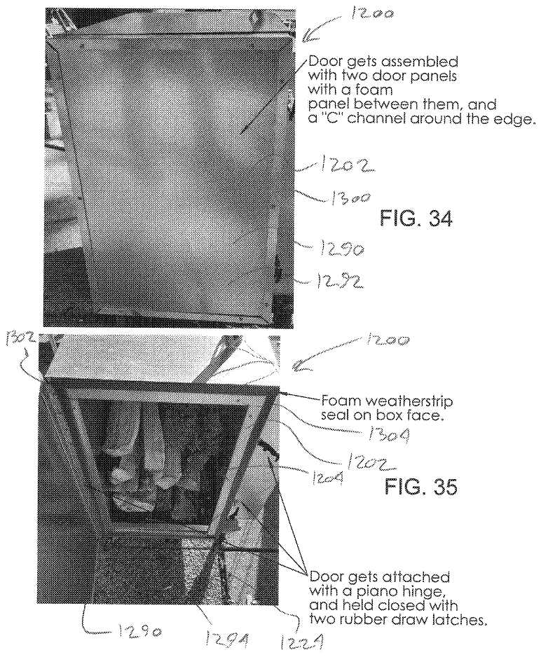

FIG. 34 depicts the cabinet 1202, including a door 1290 in a closed position relative to the chamber 1204. The door 1290 is formed as a layered structure including an exterior door panel 1292, an interior door panel 1294 (see FIG. 35), and an insulating core (not shown) disposed between the exterior door panel 1292 and the interior door panel 1294. The insulating core may include a foam panel or other insulating material suitable for reducing heat loss from the chamber 1204 during operation of the kiln 1200.

In this regard, the layered construction of the door 1290 is similar to the inner box 1244 and outer box 1250 construction of the cabinet 1202 described above, in that rigid panel layers are separated by an insulating material to provide thermal insulation while maintaining structural rigidity. In this manner, the door 1290 may include similar features and function in a similar manner as the remaining portions of the cabinet 1202 with respect to defining and insulating the chamber 1204, and storing or transporting the heat module 1210.

A peripheral “C” channel 1300 retains the layered construction of the door 1290 by extending around an edge of the door 1290 and mechanically coupling the exterior door panel 1292, the interior door panel 1294, and the insulating core together, across the door 1290 in the second direction along the floorspace 1224. In this manner, the peripheral “C” channel structurally stabilizes the door 1290 during repeated opening, closing, and thermal cycling.

The door 1290 is coupled to the cabinet 1202 by a piano hinge 1302 extending along a vertical edge of the door 1290. The piano hinge 1302 provides continuous support along the height of the door 1290, promoting alignment between the door 1290 and the cabinet 1202 during repeated opening and closing while accommodating thermal expansion of the door 1290 and the cabinet 1202 during operation of the kiln 1200.

FIG. 35 depicts the cabinet 1202, including the door 1290 in an open position relative to the chamber 1204. As shown in FIG. 35, the cabinet 1202 includes a seal 1304 that presses against the door 1290 in the closed position, prohibiting airflow between the cabinet 1202 and the door 1290 during operation of the kiln 1200. For example and without limitation, the seal 1304 may be a foam weather strip, a foam weatherstrip, an elastomeric gasket, a compressible polymer strip, or combinations thereof, that seal in compression against the cabinet 1202 and the door 1290 when the door 1290 is in the closed position, and retain integrity through repeated thermal loading cycles by the kiln 1200.

The aforementioned systems, architectures, platforms, environments, or the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity but known by those of skill in the art.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may include a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the example embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may include a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A kiln comprising:
a cabinet that defines a chamber, an inlet to the chamber, and an outlet from the chamber; and
a heat module including:
a housing fixed to an exterior of the cabinet, wherein the housing defines an interior fluidly connected to the chamber through the inlet and the outlet;
a heating element positioned within the interior; and
a blower assembly positioned within the interior, wherein the blower assembly directs airflow from the heating element, through the inlet, and toward the chamber,
wherein the heat module has an exterior footprint smaller than a horizontal cross-sectional area along a floorspace in the chamber, and an exterior height smaller than a height of the chamber.

2. The kiln of claim 1, wherein the cabinet defines the inlet in a first aperture, and defines the outlet in a second aperture, through a same side of the chamber relative to the floorspace, a first vertical distance from the first aperture, and
the housing defines a first aperture in fluid communication with the inlet, and defines a second aperture in fluid communication with the outlet, a second vertical distance from the first aperture, the second vertical distance being equal to the first vertical distance.

3. The kiln of claim 2, wherein a length of the first vertical distance is at least 90 percent the height of the chamber.

4. The kiln of claim 1, wherein a length of the exterior footprint of the heat module in a first direction along the floorspace is less than half a maximum distance of the horizontal cross-sectional area in the first direction.

5. The kiln of claim 4, wherein the heat module is a first heat module, the inlet is a first inlet, the outlet is a first outlet, the cabinet defines a second inlet and a second outlet at a side of the cabinet opposite the first inlet and the first outlet in the first direction, the housing is a first housing, the interior is a first interior, the heating element is a first heating element, the blower assembly is a first blower assembly, and the kiln comprises a second heat module including:
a second housing fixed to the exterior of the cabinet, wherein the second housing defines a second interior fluidly connected to the chamber through the second inlet and the second outlet;
a second heating element positioned within the second interior; and
a second blower assembly positioned within the second interior, wherein the blower assembly directs airflow from the second heating element, through the second inlet, and toward the chamber,
wherein the first heat module and the second heat module have a combined exterior footprint smaller than the horizontal cross-sectional area of the chamber, and have an exterior height smaller than a height of the chamber.

6. The kiln of claim 4, wherein a length of the exterior footprint of the heat module in a second direction along the floorspace and orthogonal to the first direction is greater than half a maximum distance of the horizontal cross-sectional area in the second direction.

7. The kiln of claim 1, wherein the cabinet is a box having rigid walls that enclose the chamber and define the inlet and the outlet, and
wherein the box has a minimum height of 90 inches, and has a maximum height of 110 inches, or
the box has a minimum combined length and girth of 145 inches, and a maximum combined length and girth of 170 inches.

8. The kiln of claim 1, wherein the heat module or the cabinet defines a vent to ambient atmosphere through a moisture separation membrane formed from at least one of a fibrous mineral, a coated fabric, a fibrous ceramic, or a microporous polymeric material.

9. A kiln comprising:
a cabinet that defines a chamber, an inlet to the chamber, and an outlet from the chamber; and
a heat module including:
a housing fixed to an exterior of the cabinet, wherein the housing defines an interior fluidly connected to the chamber through the inlet and the outlet;
a heating element positioned within the interior; and
a blower assembly positioned within the interior, wherein the blower assembly directs airflow from the heating element, through the inlet, and toward the chamber,
wherein the cabinet or the housing define a vent to ambient atmosphere, and include a moisture separation membrane disposed across the vent.

10. The kiln of claim 9, wherein the moisture separation membrane covers an entire cross-sectional area of the vent such that all fluid flow through the vent passes through the moisture separation membrane, and is semipermeable to water vapor exiting the interior through the vent.

11. The kiln of claim 9, wherein the moisture separation membrane is formed from rockwool, expanded polytetrafluoroethylene, or fiberglass.

12. The kiln of claim 9, wherein the moisture separation membrane is formed from a fibrous mineral, a coated fabric, a fibrous ceramic, or a microporous polymeric material.

13. The kiln of claim 9, wherein the housing defines the vent at a side of the housing opposite the cabinet, with the vent spaced between the inlet and the outlet in a vertical direction.

14. The kiln of claim 9, wherein the vent is located above the heating element and the inlet.

15. A kiln comprising:
a cabinet that defines a chamber, an inlet to the chamber, and an outlet from the chamber;
a heat module including:
a housing fixed to an exterior of the cabinet, wherein the housing defines an interior fluidly connected to the chamber through the inlet and the outlet;
a heating element positioned within the interior; and
a blower assembly positioned within the interior, wherein the blower assembly directs airflow from the heating element, through the inlet, and toward the chamber;
a sensor that measures a weight of the cabinet, including inventory stored in the cabinet; and
a controller operatively connected to the heating element, the blower assembly, and the sensor, wherein the controller determines a moisture content or weight loss rate of the inventory based on measured weights of the cabinet by the sensor over time, and ceases operation of the heating element or the blower assembly when the determined moisture content or weight loss rate falls below a predetermined threshold.

16. The kiln of claim 15, further comprising a user interface operatively connected to the controller, wherein the controller sets the predetermined threshold based on input received at the user interface, and the input directly conveys an intended use of the inventory.

17. The kiln of claim 16, wherein the controller grades the inventory based on the determined moisture content or weight loss rate compared to the predetermined threshold, and displays the grade at the user interface.

18. The kiln of claim 15, wherein the controller determines the moisture content or weight loss rate of the inventory based on:
a difference between an initial weight measurement and a subsequent weight measurement by the sensor; and
an amount of time elapsed between the initial weight measurement and the subsequent weight measurement.

19. The kiln of claim 15, further comprising a base that supports the cabinet, wherein the sensor is a load cell disposed on the base, underneath the cabinet.

20. The kiln of claim 19, further comprising a user interface operatively connected to the controller, wherein the controller and the user interface are fixed with the housing.
